(19) United States
(12) Patent Application Publication
(10) Pub. No.: US 2008/0102760 A1
(43) Pub. Date: May 1, 2008

(54) Centralized wireless communication system

(75) Inventors: Peter McConnell, Vancouver (CA); Larry J. Zibrik, Surrey (CA); W. Ross Gray, Vancouver (CA); Trent Punnett, Vancouver (CA)

Correspondence Address: THELEN REID BROWN RAYSMAN & STEINER LLP, P. O. BOX 640640, SAN JOSE, CA, 95164-0640, US

(73) Assignee: Sierra Wireless, Inc., Richmond (CA)

(21) Appl. No.: 11/906,521

(22) Filed: Oct. 1, 2007

Related U.S. Application Data
(60) Provisional application No. 60/849,146, filed on Oct. 2, 2006.

(51) Int. Cl. H04B 1/40

(52) U.S. Cl. 455/73; 455/90.2

(57) ABSTRACT

A centralized wireless communication system for a host device having a host processor and one or more host wireless communication modules includes a controller, one or more antenna elements, and an RF multiplexer coupled to the one or more antenna elements. The RF multiplexer includes one or more ports and is configured to establish an RF communication path between one or more ports and one or more antenna elements based on instructions from the controller. The centralized wireless communication system can provide adaptive noise cancellation and/or operate antenna elements as part of an active phased array.

### CROSS-REFERENCE TO RELATE APPLICATIONS

This application claims the benefit of U.S. provisional patent application No. 60/849,146, filed on Oct. 2, 2006, entitled “Wireless Computer Subsystem.”

### BACKGROUND OF THE INVENTION

1. Field of the Invention

The invention relates to wireless communication systems embedded in a host device such as a laptop or personal digital assistant (PDA).

2. Description of the Related Art

Wireless communication for computing platforms such as laptops, desktops, personal digital assistance, and the like, is ubiquitous, and many different technologies exist for its implementation. These include Bluetooth, WiFi, WLAN, for example, and a particular platform may include one or more communications modules adapted for one or more of these technologies. The technologies may be different in several respects, including different radio frequency band transmissions requiring different antenna configurations.

Since the antenna subsystem is located in close proximity to the electronics of the laptop computer or the small form factor device such as the PDA, it is susceptible to the Electromagnetic Interference (EMI) generated by the digital electronics in these platforms.

Considerable radio noise is generated by Personal Computers (PC's), as well as other portable computing devices. The noise created by these devices can interfere with the reception of signals by devices such as Wireless Wide Area Network Adapters thereby reducing the sensitivity of the adapter and hence the range to the base station.

The interference can be reduced by suppressing the noise at the source through improved design of the noise emitting electronic device. Alternatively, the noise can be reduced by choosing an antenna for the receiving device which isolates the antenna from the computer using distance (i.e., remote cable connection) or other means. However, these solutions have not been effective because of the reluctance of device manufacturers to increase product cost and a user's reluctance to use a remote cabled antenna.

A common problem with both PCMCIA and OEM wireless modules is that host generated noise can cause desense of the modem on one or more channels of the wireless data service. Desense refers to host generated Electro-Magnetic Interference (EMI) increasing the effective level of the noise floor and reducing the effective sensitivity of the receiver. Measurements have shown that desense in the laptop environment for the PCS band can be as high as 19 dB and for the 850 MHZ band can be as high as 30 dB.

The desense typically arises from digital clock noise generated by the computing device. The clock noise creates harmonics and other spectral components which lie within the bandwidth of the radio channel being used. If these spectral emissions occur within the channel being used for data communication, then problems of interference can occur. The emissions are strong enough to significantly degrade the input sensitivity of the receiver, even though their strength is low enough to meet regulatory emission requirements.

Most common current paths within an electronic device (such as a personal computer) consist of I/O cables, printed circuit board (PCB) signal traces, power supply cables, and power-to-ground loops. Each of these current paths can function as an antenna which radiates electric and magnetic fields. Interaction of these fields with other signals is EMI. The magnitude of the EMI is a function of several characteristics of the transmitted signal—such as frequency, duty cycle, and voltage swing (i.e., amplitude).

If the signal is non-periodic (such as hardware with a micro controller which references RAM, Flash, I/O devices, control lines, displays such as LCD's, etc. in a time varying fashion), the Fourier Series representation of time domain digital signals f(t) would contain terms for a wide range of fundamental components such as fundamental frequencies and all of their harmonics.

In a typical PCMCIA or OEM installation, the signal spectrum near the logic boards would appear to be fairly wideband in nature and comprise a large number of individual spectral peaks whose amplitude would vary in time with the function being performed by the digital logic of the board.

The frequency spectrum generated by the high clock speeds and sharp edges of clocks in modern digital devices can extend well into the GigaHertz region. As such, these signals may be within the allocated bandwidth of commercial communication services. As previously mentioned, these signals may be relatively low in amplitude to satisfy the requirements of regulatory emission levels. However, these signals are quite strong when compared to the Received Signal Strength Indication (RSSI) of wireless network transmissions. For example, the RSSI from a base station may be in the order of about −85 dBm, but the level of interference from nearby digitally generated noise may be in the order of −80 dBm. As is evident, a −5 dBm signal to noise ratio results in this example and would degrade the overall wireless network performance.

In a previously issued U.S. Pat. No. 6,968,171, filed on Jun. 4, 2002 and issued on Nov. 22, 2005, and pending United States Patent Application 20060030287 filed on Feb. 9, 2006, an adaptive noise cancellation method is disclosed. The disclosures of these references are herein incorporated by reference in their entirety.

In accordance with the referenced patent and patent application, there is provided a receiver with reduced near field noise having a far range receiving section that is configured to sense a desired signal having near field noise. The receiver further includes a near range receiving section configured to sense a near field noise reference signal. An adaptive noise canceller (ANC) of the receiver is configured to detect the magnitude of an error vector from the far range receiving section and adjust the phase and gain of the near field noise reference signal in response thereto. Accordingly, the ANC is configured to generate a corrected near field noise reference signal that is added to the desired signal with an adder. The near field noise is canceled by the addition of the corrected near field noise signal. The ANC uses a least mean square technique to determine the amount of correction needed.

The far range receiving section includes a far range antenna, a far range bandpass filter and a far range amplifier which are operative to sense the desired far field signal having near field noise. Similarly, the near range receiving section includes a near range antenna, a near range bandpass filter and a near range amplifier which are operative to sense the near field noise reference signal. In order to generate the corrected near field reference signal, the receiver further includes a phase corrector electrically connected to the ANC and operative to correct the phase of the near field noise reference signal in response to the magnitude of the error vector. Furthermore, the receiver includes a gain corrector electrically connected to the ANC and operative to correct the gain of the near field reference signal.

In accordance with the referenced patent and patent application, the receiver may further include a demodulator electrically connected to the ANC and operative to demodulate the signal therefrom. In order to further process the signal from the far field antenna, the receiver may further include an in-phase path and a quadrature phase path. The in-phase path has a mixer operative to mix the signal from the far field bandpass filter with a local oscillator signal that has been phase shifted by ninety degrees. The in-phase path further includes a low pass filter electrically connected between the mixer and a digital. to analog converter (DAC). The low pass filter and the DAC are operative to produce a digital representation of the received signal before processing by the ANC. Similarly, the quadrature phase path includes a mixer to mix the signal from the far range bandpass filter with a local oscillator signal. The signal from the mixer in the quadrature phase path is then passed through another low pass filter and another DAC before being inputted into the ANC.

In accordance with the referenced patent and patent application, it is also possible to correct the phase and gain of the near field noise reference signal using a tap delay line (TDL) which receives compensation coefficient signals from the ANC. Specifically, the ANC generates a gain compensation coefficient signal and a phase compensation coefficient signal in response to the magnitude of the error from the far range receiving section. The gain compensation coefficient signal is mixed with the near field noise reference signal to generate a gain compensated near field noise reference signal. The phase compensation coefficient signal is mixed with the near field noise reference signal to generate a phase compensated near field noise reference signal. Next, the gain compensated near field noise reference signal and the phase compensated near field noise reference signal are added together to generate the corrected near field noise reference signal.

In accordance with the referenced patent and patent application, there is provided a method for reducing near field noise in a desired signal. The method commences by sensing the desired signal having near field noise. Next, a near field noise reference signal is sensed. A compensation signal is then generated with an adaptive noise canceller by detecting the magnitude of an error vector from the far range receiving section. The phase and gain of the near field noise reference signal is then adjusted with the compensation signal in order to generate a corrected near field noise reference signal. Finally, the corrected near field noise reference signal is added to desired signal in order to cancel the near field noise.

### SUMMARY

As described herein, a centralized wireless communication system for a host device having a host processor and one or more host wireless communication modules includes a controller, one or more antenna elements, and an RF multiplexer coupled to the one or more antenna elements. The RF multiplexer includes one or more ports and is configured to establish an RF communication path between one or more ports and one or more antenna elements based on instructions from the controller.

Also described herein is a host device including a host processor, one or more host wireless communication modules, and a centralized wireless communication system. The centralized wireless communication system includes a controller, one or more antenna elements, and an RF multiplexer coupled to the one or more antenna elements. The RF multiplexer includes one or more ports and is configured to establish an RF communication path between one or more ports and one or more antenna elements based on instructions from the controller.

Also described herein is a method for enabling RF communication by a host device having one or more host wireless communication modules. The method includes selecting a first one of the host wireless communication modules, determining an antenna configuration specific to the first host wireless communication module, and coupling the first host wireless communication module to one or more antenna elements based on the determined configuration.

### BRIEF DESCRIPTION OF THE SEVERAL VIEWS OF THE DRAWINGS

FIG. 1 is a high level block diagram of a centralized wireless communication system.

FIG. 2 is a schematic diagram of a centralized wireless communication system embedded in a host device.

FIG. 3 is an architectural diagram of portions of centralized wireless communication system 100 in cooperation with various components of laptop computer 200.

FIG. 4 is a schematic diagram of an individual antenna element.

FIG. 4A is a schematic of a circuit for an electrically tunable band antenna.

FIG. 4B is a schematic diagram of a MA-COM AT-255 GaAs MMIC voltage variable attenuator.

FIG. 4C is a schematic diagram of a PI circuit configurations for a PIN diode attenuator.

FIG. 4D is a PIN diode attenuator schematic.

FIG. 4E is a schematic diagram of a variable reactance reflection type phase shifter.

FIG. 4F is a diagram of a Lange coupler as a 90-degree coupler.

FIG. 4G is a diagram of a reflection phase shifter using two PIN diodes to switch in or out additional line lengths 2.

FIG. 5 is a schematic diagram of an active phased array antenna.

FIG. 5A is a schematic diagram of a simple halfwave antenna element and corresponding radiation pattern.

FIG. 5B is a schematic diagram of a linear phased array antenna.

FIG. 5C is a schematic depiction of a simple two-element phased array antenna.

FIG. 5D is a depiction of a two-element phased array antenna pattern with γ/2 antenna element spacing with uniform gain branches.

FIG. 5E is a depiction of a two-element phased array antenna pattern with γ/2 antenna element spacing, uniform gain branches and 90-degree scan angle.

FIG. 5F is a depiction of a two-element phased array antenna pattern with γ/2 antenna element spacing, uniform gain branches and 45-degree scan angle.

FIG. 5G is a depiction of a two-element phased array antenna pattern with γ/4 antenna element spacing, uniform gain branches and 90-degree scan angle.

FIG. 6 is a schematic diagram of a phased array antenna with an active element.

FIG. 7 shows a comparison of a uniformly weighted phased array antenna and one having Hamming branch weights, with gains normalized to 0 dB at beam center.

FIG. 8 is a schematic diagram of system in which all the antenna subsystem elements are located on a single printed circuit board that provides a large ground plane for all antenna elements.

FIG. 9 is an electrical schematic diagram of 1×4 and 1×2 RF switches.

FIG. 10 is a schematic diagram of a three-in/four-out multiplexer.

FIG. 11 is an RF switch matrix logic table.

FIG. 12 is a plot of 8-PSK baseband signal with low EVM.

FIG. 13 is a plot of 8-PSK baseband signal with high EVM.

FIG. 14 shows a form factor of a Taiyo-Yuden Bluetooth modem.

FIG. 15 shows a form factor of a Quatech 802.11/bg modem.

FIG. 16 shows a Sierra Wireless™ MC8755 PCI Express MiniCard.

FIG. 17 is a schematic diagram of a system incorporating various antenna elements.

FIG. 18 is a electric schematic diagram of a three-element beam switch multi-band phased array.

FIG. 19 is a table showing switch logic for six WLAN antenna modes.

FIG. 20 is a depiction of a two-element phased array antenna pattern for a broadside beam using antennas A₁ᵥ and A₃ᵥ from FIG. 17 for a 850/900 MHz bands 0-degree phase shift and equal gains.

FIG. 21 is a depiction of a two-element phased array antenna pattern for a broadside beam using antennas A₁ᵥ and A₂ᵥ from FIG. 17 for a 850/900 MHz bands +90 degree phase shift and equal gains.

FIG. 22 is a depiction of a two-element phased array antenna pattern for a broadside beam using antennas A₁ᵥ and A₂ᵥ from FIG. 17 for a 1800/1900 MHz bands 0-degree phase shift and equal gains.

FIG. 23 is a depiction of a two-element phased array antenna pattern for a broadside beam using antennas A₁ᵥ, A₂ᵥ, and A₂ᵥ, from FIG. 17 for a 1800/1900 MHz bands +90-degree phase shift and equal gains.

FIG. 24 is a graph of an example of QoS application mode selection criteria.

FIG. 25 is a table showing MC8755 receive signal strength static sensitivity metrics.

FIG. 26 is a flow diagram showing a method for enabling RF communication by a host device.

FIG. 27 is a diagram illustrating an error vector and its components.

### DETAILED DESCRIPTION

The description herein is provided in the context of centralized wireless communication controller. Those of ordinary skill in the art will realize that the following detailed description is illustrative only and is not intended to be in any way limiting. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

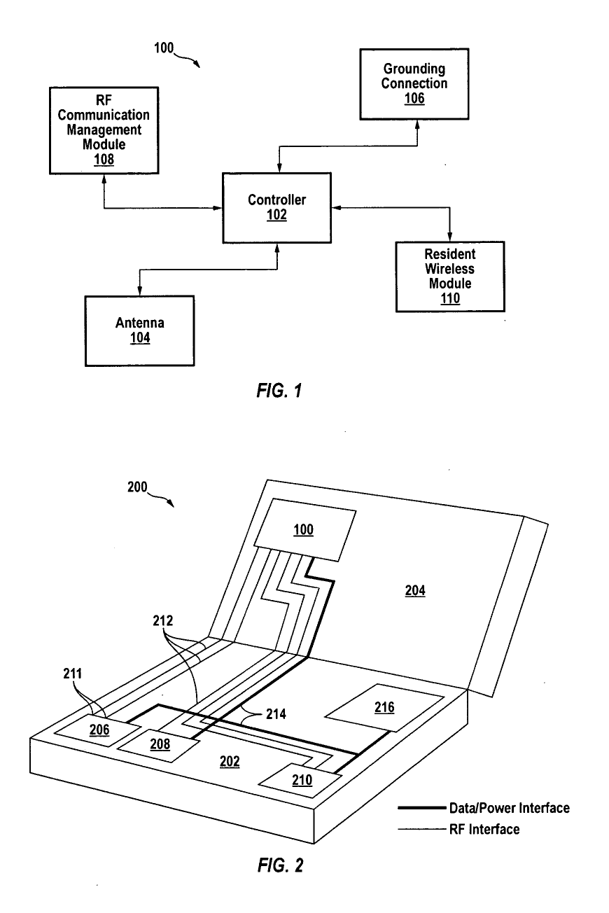

FIG. 1 is a high level block diagram of a centralized wireless communication system 100. Generally, components of system 100 include a controller 102 in communication with an antenna module 104, a grounding/connection module 106, a radio frequency (RF) communication management module 108, and a resident wireless communication module 110. It will be appreciated that the functions and operations of these modules may overlap partially or completely, and that they are described herein in terms of separate modules primarily for convenience and ease of understanding.

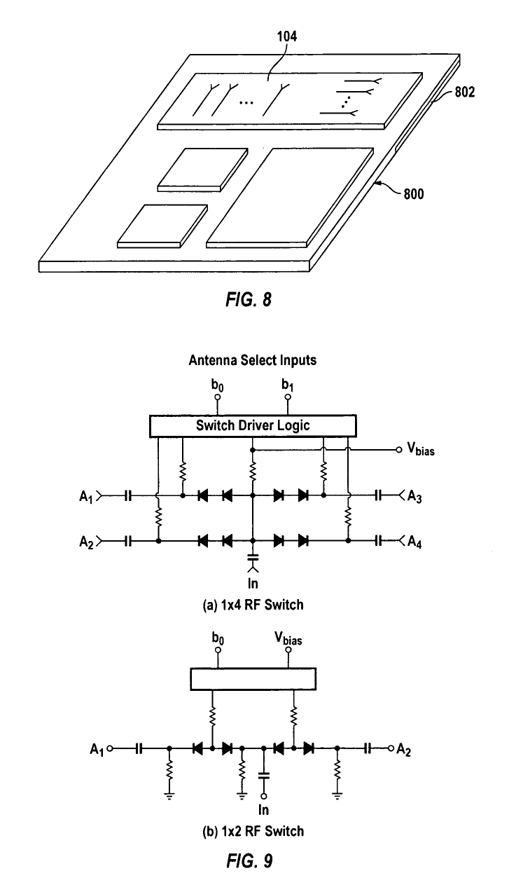

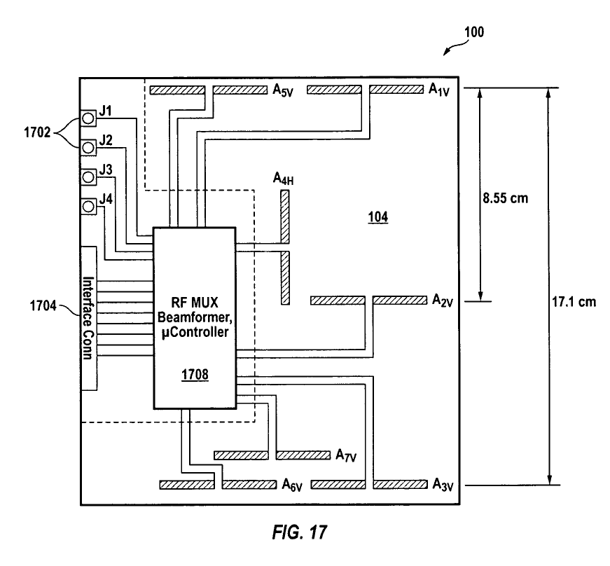

As seen in FIG. 2, centralized wireless communication system 100 is embedded in a host device or platform. In the example herein, the host device is a laptop computer 200, but other host devices, such as PDAs (personal digital assistants) and desktop computers are also contemplated. Laptop computer 200 includes a main housing 202 and a top cover 204. Typically, a display (not shown) is provided in top cover 204. Also provided in top cover 204 is system 100, in whole or in part. Some or all of the components of system 100 may be integrated on a single, dedicated printed circuit board (PCB) (see for example FIGS. 8 and 17), which may be solid or flexible, and which in this example is mounted in top cover 204.

The main body 202 of laptop computer 200 includes host wireless modules 206, 208 and 210. These host wireless modules may be any combination of wireless devices based on technologies such as Bluetooth™, Wifi™, WLAN, and so forth. Each host wireless module 206, 208 and 210 has one or more antenna ports 211 that are coupled to system 100 by way of RF (radio frequency) interface or cabling 212, for example co-axial cabling. Cabling 212 is delineated by the relatively thinner connection lines in FIG. 2 and corresponds to grounding/connection module 106 in FIG. 1. Host wireless module 206 is shown to have two antenna ports 211 coupled to system 100; host wireless module 208 is shown is shown to have one such antenna port (not labeled); and host wireless module 210 is shown to have two such antenna ports (not labeled). The system 100, and cabling 212 operate to ensure high efficiency connections from other wireless services within the host device 200. The system 100 specifies the grounding system in the host mPCIe slot (not shown) area in which the host wireless modules 206, 208 and 210 are disposed so as to minimize common mode and differential noise entering the system. The system 100 is properly grounded to the system to achieve the same outcome. The system 100 specification can include specific coaxial cabling specifications including recommendations for cable types to improve insertion loss and minimize host noise intrusion for radiated or conducted sources. The cabling and grounding system 212 supports an antenna counterpoise system that allows for maximum efficiency while minimizing interference in the system. The antenna system while actively transmitting will not impact the performance of the main system due to excessive RFI.

Laptop computer 200 also has a data and power interface or cabling 214 between the centralized wireless communication system 100, the host wireless modules 206, 208 and 210, a host processor 216, and possibly other components (not shown) of the laptop computer. The data and power interface or cabling 214 between each of the host wireless modules 206, 208 and 210 and the other components of laptop 200, including system 100, can be a parallel- or serial-type connection, for example a Universal Serial Bus or USB connection, depending on the nature of the wireless module. The system 100 and cabling

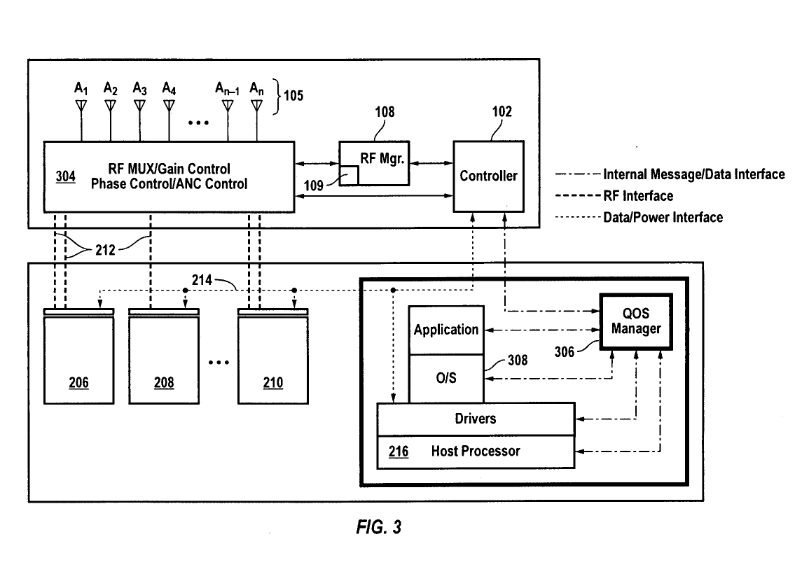

As further detailed below, centralized wireless communication system 100 generally operates to provide several functions, including a matrix switch function between the antenna ports 211 of host wireless modules 206, 208 and 210 and any number of antenna subsystems in antenna module 104 (FIG. 1). It also operates to provide an efficient common RF ground, preferably inside top cover 204 of laptop computer 200. The matrix switch function permits various antenna subsystems to be selected for any of the host wireless modules 206, 208 and 210 based on operating band, polarization of the antenna, multiple antenna requirements such as a directive array or MIMO (multiple-input multiple-output) communications, noise reduction necessitated by the proximity of noisy host components, improved performance, and so on. Each antenna subsystem of antenna module 104 may have a selective center frequency, a specific polarization (horizontal, vertical, right circular, left circular, etc.), and can be configured to operate as an active element or a passive element/radiator. In addition, the gain (scaling factor) and phase of each element may be adjusted such that an adaptive array can be formed from a subset of antenna elements or subsystems. Antenna module 104 provides antenna functionality for a wide range of wireless communication standards as well as smart antenna functionality, and the sensing means to implement the adaptive noise cancelling functionality (ANC) detailed below. It will be appreciated that adaptive noise cancellation (ANC) is a specific instance of the more general noise suppression functionality, which may be provided by a separate module or a submodule 109 (FIG. 3) of RF communication management module 108 in FIG. 1. The discussion herein will focus on ANC, although it will be appreciated that other specific types of noise suppression are contemplated.

Host processor 216 supports all of the user applications typically found in platforms like laptop computer 200. It also provides a software and digital interface to the host wireless modules 206, 208 and 210. In addition, specific applications are run on the host processor 216 which interface with controller 102 (FIG. 1) of system 100. Software running on the host processor 216 and/or the controller 102 selects, for example, the appropriate antenna configuration for the particular host wireless module 206, 208 and 210 operation. This will typically depend on the specific application requirements and/or wireless network availability, and other conditions.

FIG. 3 is an architectural diagram of portions of centralized wireless communication system 100 in cooperation with various components of laptop computer 200. An array 105 of antennas (A₁-Aₙ) of antenna module 104 (FIG. 1) are selectively recruitable by a radio frequency multiplexing circuit (RF MUX) 304 coupled to host wireless modules 206, 208 and 210 by way of RF interface or cabling 212. Although not shown in FIG. 3, the array 105 of antennas (A₁-Aₙ) of antenna module 104 are also coupled to resident wireless module 110 (FIG. 1) by way of radio frequency multiplexing circuit (RF MUX) 304 when such a resident module is present. RF interface or cabling 212 serves to provide a standardized connector interface to the system 100 PCB, as well as to provide a standard impedance at each connector (for example, 50Ω). Data and power interface or cabling 214 serves to provide the appropriate information exchange medium between the various components. Multiplexing circuit 304 is in communication with adaptive noise cancellation (ANC) module 109 and with controller 102. As explained above, ANC 109 is a specific example of the more noise suppression functionality which is contemplated. ANC 109 provides, inter alia, the ability to cancel local interference which cannot be addressed by the smart antenna scheme further detailed below. This may or may not be required, depending on the nature of the interference generated in or near the host laptop computer platform 200.

Centralized wireless communication system 100 is configured to accept various inputs from for example mPCIe wireless services cards located in the bay slots of main body 202 of laptop computer 200. The system 100 presents a nominal matched impedance (i.e., 50Ω) to these services in order to maintain maximum signaling efficiency by minimizing losses. The system 100 accepts a single external transmit input from the bay slots and ensures that this signal level does not cause damage to the controller, power supplies or antenna systems. The controller operates to balance thermal signatures to ensure that ambient temperatures or spot temperatures against sensitive components such as displays do not affect the performance of the system.

The system 100 operates in accordance with regulatory and industry (GCF/PTCRB/CTIA/CDG) requirements and is responsible to connect antenna systems and can accept commands from the computer 200 operating system in order to arbitrate active services. It can also determine its own quality of service metrics for assisting or overriding the service preferences. The system 100 uses solid state inputs for other RF inputs and antenna system connections. These connections provide maximum impedance load stability and minimal insertion loss. The system 100 has the ability to measure and buffer signal levels and quality for connected services for mPCIe inputs as well as other outputs. The system 100 allows for a “no stuff” option in which the platform—for example, laptop 200—is fully functional in its absence. In this manner, the platform can be sold and operated without the system 100. The system 100 can subsequently be installed as an upgrade.

Generally, antennas (A₁-Aₙ) of array 105 may be provided on a single substrate (FIGS. 8 and 17) or on multiple substrates (not shown). Antenna module 104, which includes antennas (A₁-Aₙ) of array 105, is designed to be a known, versatile physical component that is adaptable for use with any platform, such as laptop computer 200. It functions to consolidate multiple services, reducing the complexity of designing numerous separate antenna systems into a single end user device. The antenna module 104 couples to resident wireless communication module 110, but is not dedicated exclusively thereto; rather, it also couples to the host wireless modules 206, 208 and 210 and provides these with antenna functionality. The antenna module 104 is designed to minimize size and weight while maximizing performance and minimizing the impact from electromagnetic noise from the host platform 200. It may be a passive element that can be steered, fed and controlled by the controller 102, as further detailed below.

A quality of service (QoS) module 306 is in communication with controller 102, and may reside on the host laptop computer platform 200 and/or in system 100. QoS module 306 may for example be software running on the laptop computer platform 200 which interfaces host wireless modules 206, 208 and 210 to the host computer, and provides a control interface to the system 100. It may also collect various metrics from the host wireless modules 206, 208 and 210 that are used in a QoS application to drive the antenna module 104 beamforming functionality and adaptive noise cancelling functionality as detailed below.

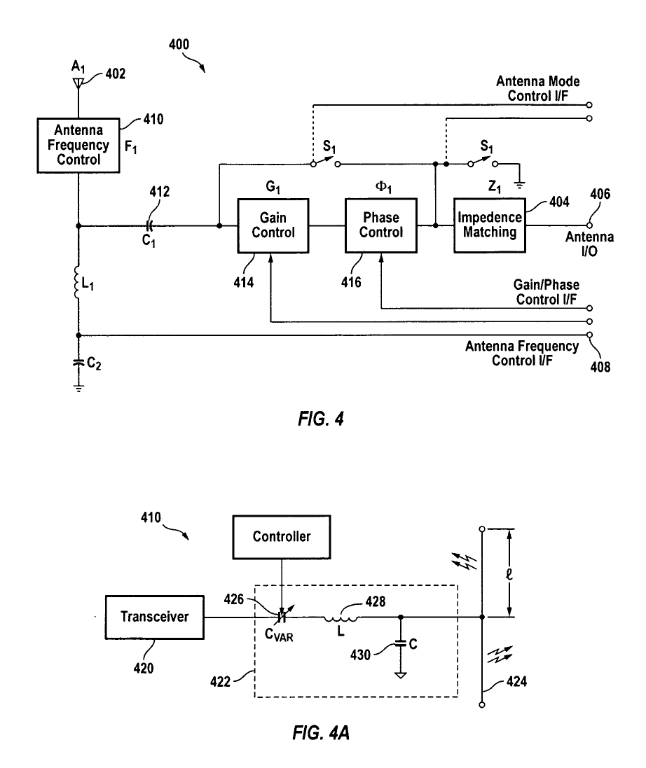

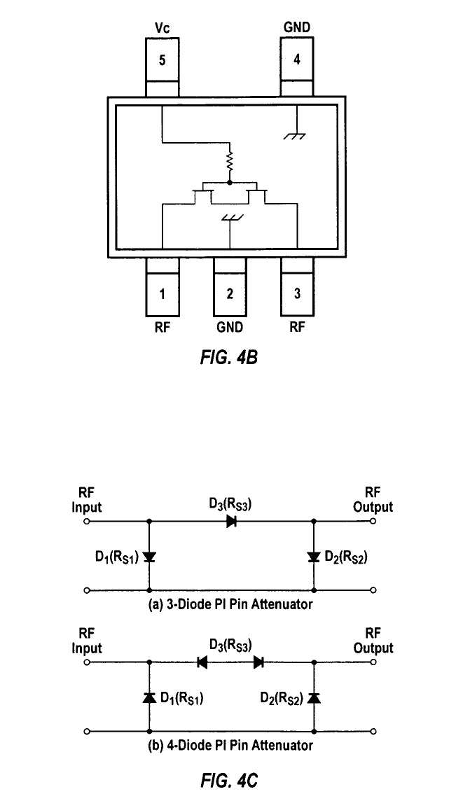

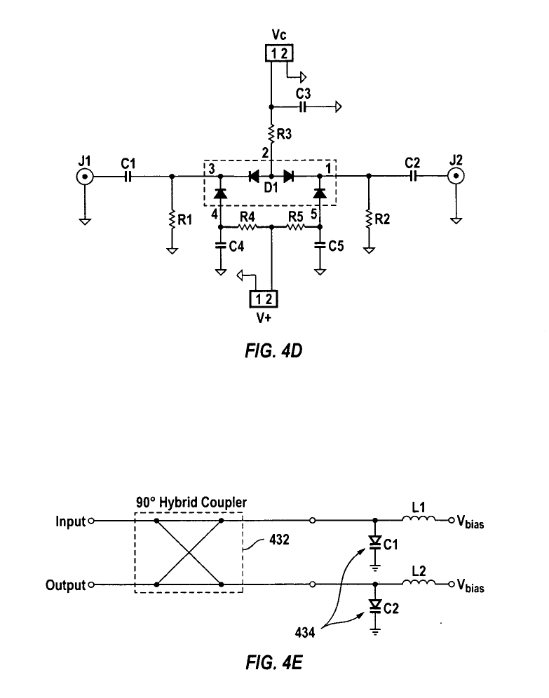

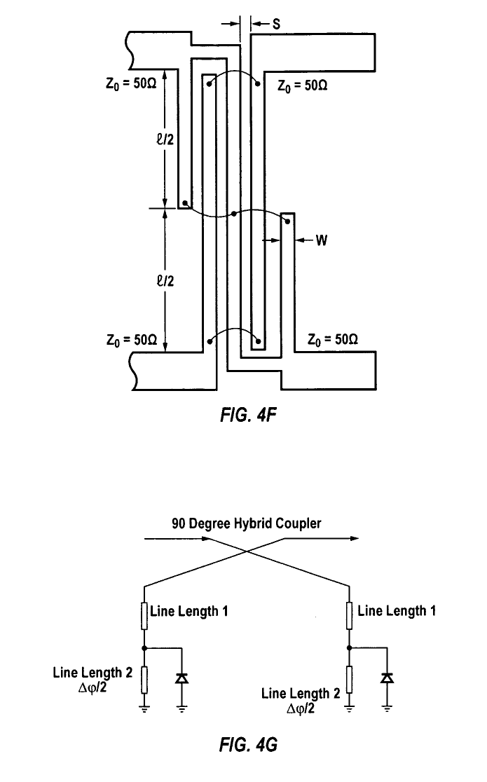

FIG. 4 shows an individual antenna element 400 of antenna module 104 (FIG. 1). One or more of antennas (A₁-Aₙ) of array 105 can be configured in this manner so as to function as a universal antenna element. In the example of FIG. 4, antenna element 400 includes antenna (A₁) 402 and impedance matching circuit (Z₁) 404 to match the antenna impedance to the antenna input/output 406 such that antenna input/output impedance appears as a standard input impedance (e.g., 50Ω). The impedance matching circuit (Z₁) 404 consists of various circuit elements to match the RF port of the system to the RF MUX 304 (FIG. 3) such that the antenna module 104 looks like a constant 50Ω impedance, eliminating the need to match the resident wireless module 110 (FIG. 1) or the host wireless communications modules 206, 208 and 210 (FIG. 2).

An antenna frequency control I/F 408 provides a DC control signal to the antenna frequency control block (F₁) 410 such that the antenna center frequency may be controlled through this control signal. The DC control signal can act as a logic level selecting one antenna center frequency or another, or it may be continuously variable such that the antenna center frequency may be swept continuously over a range of frequencies. Capacitor (C₁) 412 acts as a DC Block between the antenna (A₁) 402 and antenna frequency control block (F₁) 410, and L₁/C₁ act as an RF block to decouple the RF from the DC control line.

Frequency control of an antenna is described in U.S. Pat. No. 6,697,030, the contents of which are incorporated herein by reference in their entirety. As shown in detail in FIG. 4A, a frequency control circuit (F₁) 410 in the form of a dual band tuning circuit, includes a transceiver 420, a matching network 422, and an antenna 424. The matching network 422 is operable to tune the antenna 424 to the transceiver at both a first and second frequency. Accordingly, the matching network 422 has a variable capacitor (C_{VAR}) 426, an inductor (L) 428 and a second capacitor (C) 430. The value of the variable capacitor (C_{VAR}) 426 is selected to tune the antenna 424 at the first frequency and the second frequency such that the system can be used to transmit and receive electromagnetic energy over two bandwidths. The values of the variable capacitor (C_{VAR}) 426, the inductor (L) 428, and the second capacitor (C) 430 are selected to minimize the standing wave ratio of the system at both the first frequency and the second frequency.

The individual antenna element 400 of FIG. 4 includes a gain control or correction circuit (G₁) 414 for providing variable gain scaling between the antenna I/O port 406 and the antenna (A₁) 402. This scaling may be fixed or variable. For example, in a fixed step attenuation mode the gain correction could consist of selectable attenuation steps of 0, 1, 2, 3, 4, . . . 10 dB. In a continuously variable mode the gain could be adjusted from for example about 0 dB to about 10 dB using an analog control voltage.

There are numerous ways to implement a gain control block. In the example provided herein, a gain control block or circuit (G₁) 414 with adjustable gain of less than or equal to about 1.0 is suitable. This can be accomplished with an adjustable attenuator, which can be realized in a number of forms such as PIN diode attenuators or GaAs MESFET attenuators. FET based attenuators are available in small surface mount packages from a numbers of vendors, such as Skyworks (the AV 108-59 GaAs IC 35 dB Voltage Variable Attenuation an MSOP-8 package), AM-COM (AT 255 GaAs MMIC Voltage Variable Attenuator) and others. They may also be fabricated from discrete GaAs MESFET devices. An example of a commercially available attenuator by MA_COM is shown in FIG. 4B. For matched broadband applications, especially those covering low RF frequencies (to 5 MHz) through frequencies greater than 1 GHz, PIN diode designs are commonly employed. The circuit configurations most popular are the TEE, bridged TEE and the PI. All these designs use PIN diodes as current controlled RF resistors whose resistance values are set by a DC control, established by an AGC (automatic gain control) loop.

PI configurations can be implemented in a number of configuration, two of these being the 3-diode and the 4-diode configurations shown in FIG. 4C. A benefit of the four-diode circuit is its symmetry, which allows for a simpler bias network and a reduction of distortion due to cancellation of harmonic signals in the back-to-back configuration of the series diodes. The model HSMP-3816 from Avago Technologies is a diode quad housed in a five-pin, leadfree SOT-25 surface mount package. When PIN diodes are used as attenuating elements, they offer higher linearity than equivalent GaAs MESFETs. At low attenuation, most of the RF energy is simply transferred from the attenuators's input to the output port. However, at higher attenuation levels, more of the RF energy is dumped into the attenuator and, consequently, the distortion level rises. When the value of V_{c} approaches zero, almost no current flows through the two series diodes. With these two diodes operating close to zero bias condition, their junction capacitance will vary in synchrony with the RF voltage. Fortunately, some of the distortion generated by the RF modulated capacitance will cancel out because of the two diodes' anti-series connection. The four diodes in one package concept ensures that the distortion cancellation is optimum as the two anti-series diodes are more closely matched than is possible-using two randomly picked diodes. A schematic diagram of a 4-diode PI Attenuator using a HSMP-3816 quad PIN Diode package is shown in FIG. 4D.

With reference again to FIG. 4, the individual antenna element 400 can also include a phase control block or circuit 416, shown in greater detail in FIG. 4E. Phase control block or circuit 416 is configured to provide variable phase shifting between the antenna I/O port 406 and the antenna (A₁) 402. This phase shift may be fixed or variable. For example, in a fixed step phase shift mode the phase shift could consist of selectable phase delays of steps of about 0°, 10°, 20°, 30°, 40°, . . . , 180°. In a continuously variable mode the shift could be adjusted from about 0 degrees to about 180° using an analog control voltage.

Phase control can be realized in a number of ways, such as with phase shifters. A phase shifter is a two-port network in which the phase difference between the input port and the output port may be controlled by a control signal. This phase shift can be considered “digital” in the sense that only predetermined discrete values can be selected, such as 22.5°, 45°, 67.5°, 90°, etc., or it may be analog in the sense that it is continuously variable over a range (such as 0° to 180°). The design of phase shifters is well known, and is described in detail in various references, such as “Microwave Solid State Circuit Design,” Inder Bahl and Prakash Bhartia, John Wiley and Sons, Inc., 1988, ISBN 0 471 83189 1. In this reference, a discussion of reflection- and transmission-type phase shifters is provided. The type of phase shifter used in this example and shown schematically in FIG. 4E is the Variable Reactance Reflection Type Phase Shifter. It uses a 90° hybrid coupler (such as a Lange or Rat-Race) 432 and variable reactances, in this case varactor diodes or varactors (C₁, C₂) 434, to provide a variable capacitance. The hybrid coupler 432 provides a two-port network and the varactors (C₁, C₂) 434 provide continuously variable reactance, providing phase shifts of nearly 180° in practice. Inductors L₁ and L₂ isolate the bias control voltage from the varactor diodes 434. They are also capable of wideband operation. The 90° hybrid coupler 432 is realizable in a number of forms, many of these ideally suited to micro-strip implementations on printed circuit boards. One example is the Lange coupler shown in FIG. 4F. It will be appreciated by those skilled in the art that there are many other choices of hybrid couplers which can be selected depending on the specific application implementation considerations such as operation bandwidth, and so on.

Phase shifter modules are also available commercially from a number of vendors such as Mini-Circuits, MA-COM, etc. An example is the JSPHS-1000 180° Voltage Variable phase shifter from Mini-Circuits of Brooklyn, N.Y. In addition, it is possible to use a switched line reflection phase shifter, described with reference to FIG. 4G. Reflection phase shifters work by having switchable terminations which create switchable reflection coefficients. The main type of reflection phase shifter uses switched line lengths either by using a PIN switch or by a variable reactance (e.g., varactor) to alter electrical length. In both cases the signal incurs twice the extra electrical length as the signal is reflected back. The simplest example is to use a 90-degree hybrid (e.g., Lange or Rat-race) and two PIN diodes to either short to ground bypassing line length 2 or switched out thus adding line length 2 and adding a longer path for the signal to travel.

It should be noted that a phase shifter with digitally selected discrete phase shifts can also be used. If the discrete phase shifts are less than the 3 dB beamwidth of the phase array, then effective beam steering can be achieved with these discrete phase shifts. Discrete phase shifters can be implemented by a number of means such as switched line phase shifters, loaded-line phase shifters, switched-line reflective phase shifters, etc. They are available from a number of commercial vendors such as Mini-Circuits, MA-COM, etc.

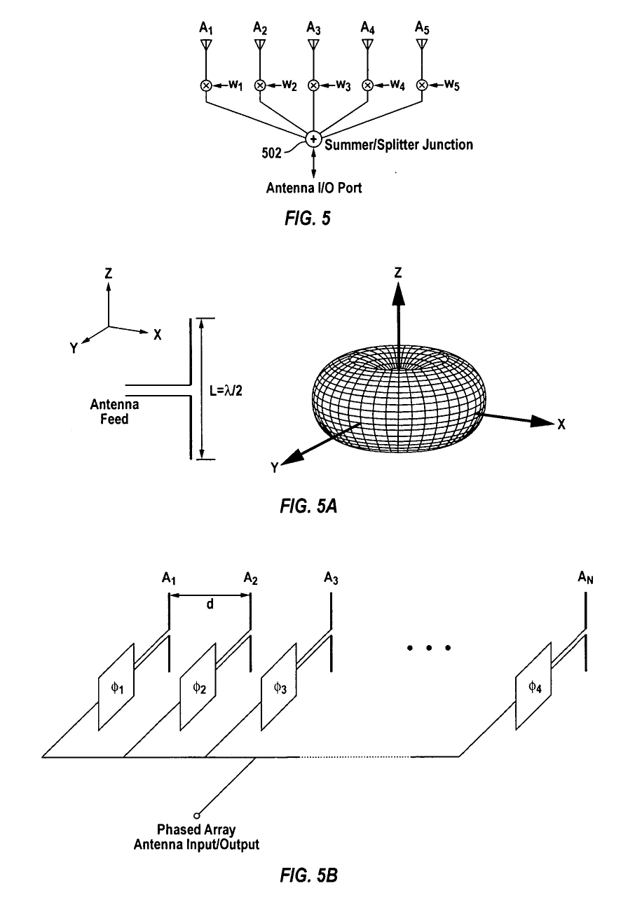

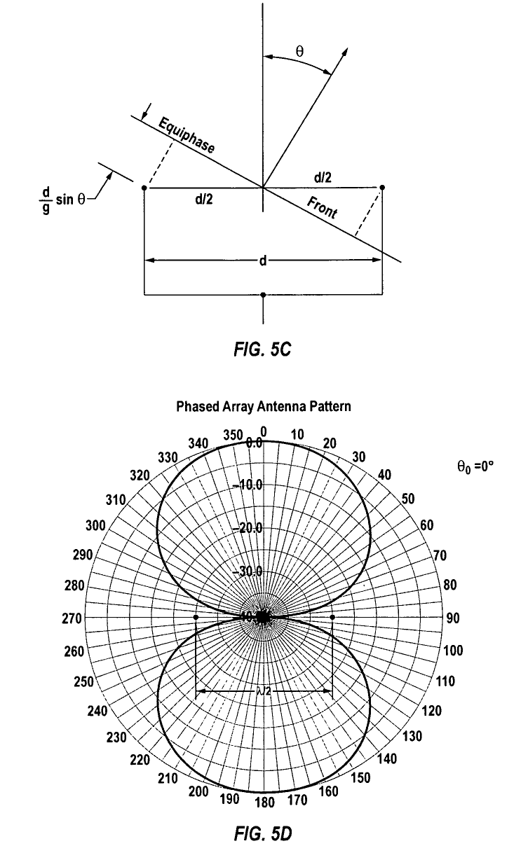

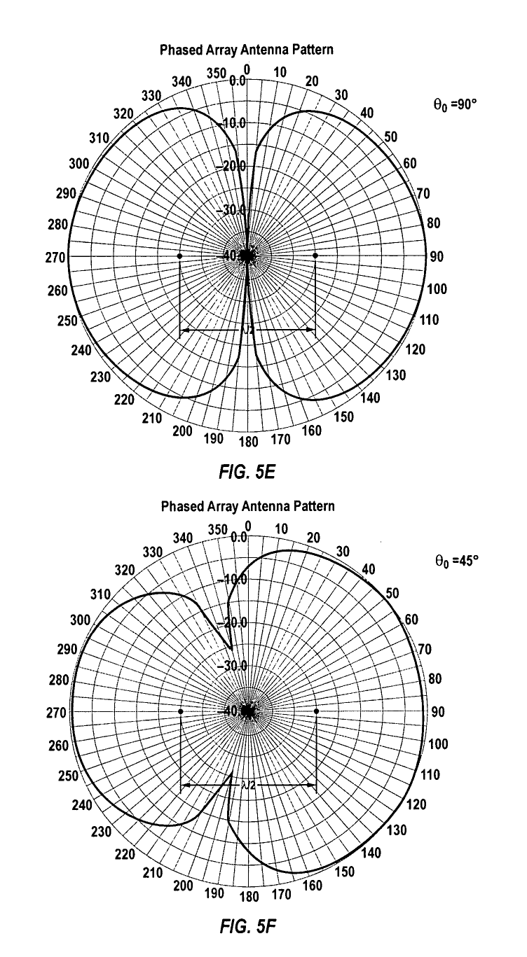

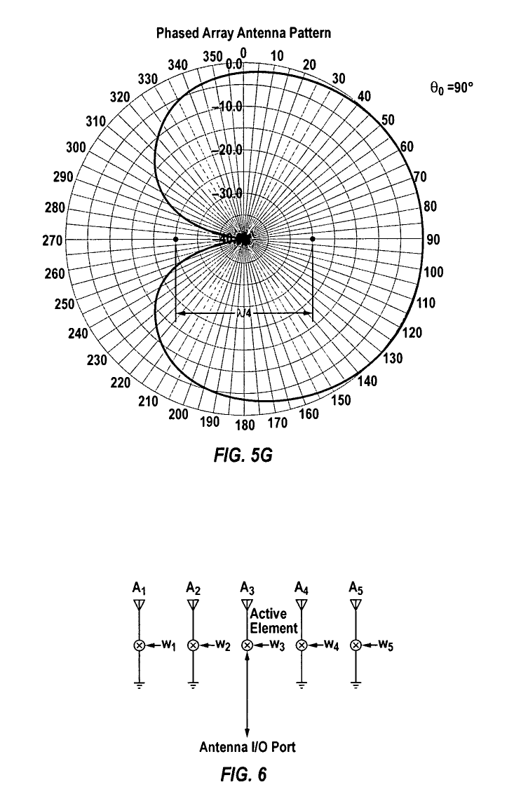

A plurality of antennas An of array 105 of antenna module 104 can be operated as an active phased array, described with reference to FIG. 5. Antennas A₁-A₅ are selected as “active” antenna elements which have gain coefficients G₁, G₂, G₃, G₄ and G₅. By active, it is meant that the individual antenna branches are connected to the summer/splitter junction 502. The phase delays are θ₁, θ₂, θ₃, θ₄ and θ₅. The antenna weights given in their polar form are
wᵢ=Gᵢ·e^{jΦ}i

By properly selecting the weighting coefficients of each individual antenna element, the main lobe and/or the null can be steered in a particular direction. With reference to FIG. 5A, it is understood that one single element half wave dipole has a circular symmetric radiation pattern. If one were to place the half-wave element in the z-axis, the radiation pattern would be a doughnut shape oriented in the x-y plane. The simple half wave dipole elements can be organized to form a linear array. Each of the antenna elements has individually adjustable gain and phase elements, for example as seen FIG. 4. Initially, gains for each the elements will be considered to have equal gains and there will be only phase adjustments in each branch. The benefits of adjustable gain for each element are explained below.

A diagram of a simple linear antenna array is shown is shown in FIG. 5B. As can be seen, N half-wave dipole antenna elements are separated by a distance d, individual phase shifter elements Φ_{N} are provided in each branche, and equal gain weighting is provided for each branch. The antenna elements are co-linear.

The scan angle θ₀ of the linear array is the normal to the equiphase front from the array, as can be seen from FIG. 5C depicting a simple two element phased array antenna. The angle θ is measured relative to the linear array axis. With equal delay in each of the branches, the scan angle is at right angles to the linear array. It can be shown (see for example, “Phased Array Antennas,” R. C. Hansen, John Wiley & Sons, Inc., 1998, ISBN 0 471 53076) that for the general case of an N-element linear phased array antenna with equal branch weights, adjustable branch phases, element separation d, RF wavelength λ, and nominal scan angle θ₀, it can be shown that the antenna pattern F(u) is given by;
F(u)=ΣA_{π}exp[jkd(n−1)u].

where

u=(sin θ-sin θ₀)

k=2π/d

Where the array elements have uniform excitation (that is, equal gains), the expression simplifies to

$$F ( u ) = exp [ jπ ( N - 1 ) u ] \frac{sin \frac{1}{2} Nkdu}{N sin \frac{1}{2} kdu}$$

Each of the antenna elements on its own has a uniform circular radiation pattern in the x-y plane, as previously explained. Such an antenna when installed in a platform such as a laptop computer 200 provides an omni-directional radiation pattern that is insensitive to how the laptop was oriented in the x-y plane. It should be noted, however, that situations do arise when such an omni-directional radiation pattern may not be desired. Some of these situations may be:
(1) the laptop 200 is situated in an environment in which the received signal level is poor to marginal, resulting in degraded performance (dropped packets, low throughput, etc.); and
(2) there may be an in-band noise sources nearby which creates co-channel interference which could result in degraded performance, even to the point that the wireless communication link cannot be maintained.

In case (1), a phased array antenna can be used to modify the shape of the antenna radiation pattern such that it provides higher gain in the direction of the base station associated with the wireless device (110, 206, 208 and 210) inside the laptop 200. This is done by having the RF MUX 304 select two or more of the antenna elements and combine them such that a linear array is formed. If the elements have uniform gain (unity gain assumed this case) and only vary the phase of each antenna subsystem element, then the main lobe of the array can be steered toward the direction of greatest signal level, or some other metric can be optimized, for example that relating to the error vector magnitude (EVM) of the baseband signal. To demonstrate this case, assume the following:

2 antenna subsystem elements

unity gain for each antenna subsystem element

half wave dipole antenna element

spacing between the elements of 0.5 wavelength

the only variable parameter in the antenna array subsystem is the scan angle θ₀.

The case where θ₀=0° is shown in FIG. 5D. In this case a broadside pattern with symmetric lobes at right angles to the axis of the antenna is established. This phased array has higher gain in the main lobes (about 3 dB) than a single dipole, but is has much reduced gain off-axis, especially at right angles to the main lobes.

Either of these main lobes may not point towards the base station associated with the wireless device inside the laptop, but the phase of the branches can be varied to “steer” the main lobe towards the base station. By electrically changing the phase in each branch, the scan angle θ₀ can be adjusted to achieve this steering. An example is shown in FIG. 5E, wherein the scan angle θ₀ has been electrically adjusted to 90°. This causes the phased array antenna to act like an endfire antenna as opposed to a broadside antenna and it has the highest gain along the axis of the antenna elements.

If the scan angle is electrically adjusted such that θ₀=45°, then a somewhat asymmetric beam is created where the peak gain occurs at +45° and +125°. This is shown in FIG. 5F. Using the variable phase delays in each of the antenna subsystem elements, the controller 102 (FIG. 1) can essentially scan the main lobe +90° to −90° degrees in order to achieve the highest signal strength and/or the best error vector magnitude (EVM) for the radio channel it is tuned to.

An additional advantage of these schemes is the ability to compensate for the destructive presence of other electrically conducting surfaces in the host platform—that is, laptop computer 200—which may interact with the actual antenna elements in the antenna module 104 such that these conducting surfaces act like parasitic elements and that disturb the radiation pattern of the antenna module so as to actually degrade the performance. By steering the active elements through various angles, it is possible to steer the main lobe towards the base station and improve the signal quality.

As previously mentioned, another destructive force is electromagnetic interference generated near the laptop computer 200 or by components of the computer. These can create co-channel interference which may degrade the desired received signal. In such a case, rather than steering the main lobe towards a base station to improve signal strength, the beam pattern null(s) can be steered towards the source of interference such that their effects are suppressed. In the aforementioned configurations, a simple two element phased array can steer nulls on the order of 40 dB below the main lobe gain. This could allow communications to be supported in an environment in which it might not normally be possible.

In an alternative approach, an antenna array with the following characteristics can achieve a different radiation pattern:
two antenna elements
unity gain for each antenna subsystem element
half wave dipole antenna element
spacing between the elements of λ/4 (quarter wavelength)
the only variable parameter in the antenna array subsystem is the scan angle θ₀.

As noted, the element spacing is ¼ wavelength as opposed to the ½ wavelength discussed above. The radiation pattern for the case with a scan angle of θ₀=90° is unidirectional and shown in FIG. 5G. The pattern is a classic cardiod pattern and provides a unidirectional endfire response for the antenna array. The antenna can be aimed in the opposite direction by varying the scan angle to 270°.

Based on the above, it will be appreciated that if the antenna subsystem consisted of a sufficient number of antenna elements arranged in a linear fashion, then a very flexible antenna system is achieved. It allows a single antenna element to be connected to a wireless module such as resident module 106 or host wireless modules 206, 208 and 210 such that a traditional omnidirectional radiation pattern is achieved. Alternatively, various elements may be combined such that a phased array pattern can be configured to achieve a highly directive radiation pattern to provide a higher gain main lobe in a particular direction or to steer a null in the beam pattern towards an undesired interferer.

It is also possible to have only one active element in phased array, and have the remaining elements be passive or parasitic in nature. This configuration is shown in FIG. 6. Active antenna A₃ is shown in an array that includes passive elements A₁-A₂ and A₄-A₅. A passive radiator or parasitic element is a radio antenna element which does not have any wired input. Instead, it absorbs radio waves radiated from another active antenna element in proximity, and re-radiates it in phase with the active element so that it adds to the total transmitted signal. This changes the antenna pattern and beam width. Parasitic elements can also be used to alter the radiation parameters of nearby active elements. An example of this is the placement a parasitic microstrip patch antenna above another driven patch antenna. This antenna combination resonates at a slightly lower frequency than the original element. However, the main effect is to greatly increase the impedance bandwidth of the antenna. In some cases the bandwidth can be increased by a factor of 10. In the example of FIG. 6, antenna elements A₁-A₂ and A₄-A₅ are connected to ground, while their actual gain and phase is still adjustable (wₙ inputs) so that the overall array still operates as a phased array antenna.

As is contemplated herein, adjustable phase and gain control of individual elements, as well as the ability to select which elements of the array are active and which are passive allows a number of the individual elements to be combined into a “phased array structure” in which the individual element gains and phases are adjusted to steer a main lobe or a beam null in a particular direction, as well as to shape and form the individual element beam patterns into a different pattern with advantageous characteristics. Such an antenna structure is generally described as a “Phased Array Antenna” and can be implemented using active elements or it can be implemented with a combination of active and passive elements.

One of the simplest methods of beam forming is to simply “weight” the individual branches of the phased array antenna before the summing. This provides the ability to shape the main lobe and suppress the side lobes. In all cases, the main lobe of the shaped beam will be broader than that for a uniformly weighted array, but the sidelobes can be suppressed dramatically. In order to illustrate this, consider the example of a 5 element phased array with 0 phase shift in all of the elements. This creates a symmetric broadside antenna pattern. In the case of uniform branch weights, this creates a classic sin(x)/x beam pattern in which the first side lobe is down from the main lobe by −13.2 dB. Next, consider the case where the branch weights are weighted by a Hamming Window which is symmetric about the center branch. That is, the branch weighting function is:

$$w ( n ) = 0.54 - 0.46 cos ( 2 π \frac{n}{N} ) , 0 \leq n \leq N$$

For a five element phased array antenna, this means that the branch weights would be:

W(1)=0.3098

W(1)=0.7696

W(1)=1.000

W(1)=0.7696

W(1)=0.3098

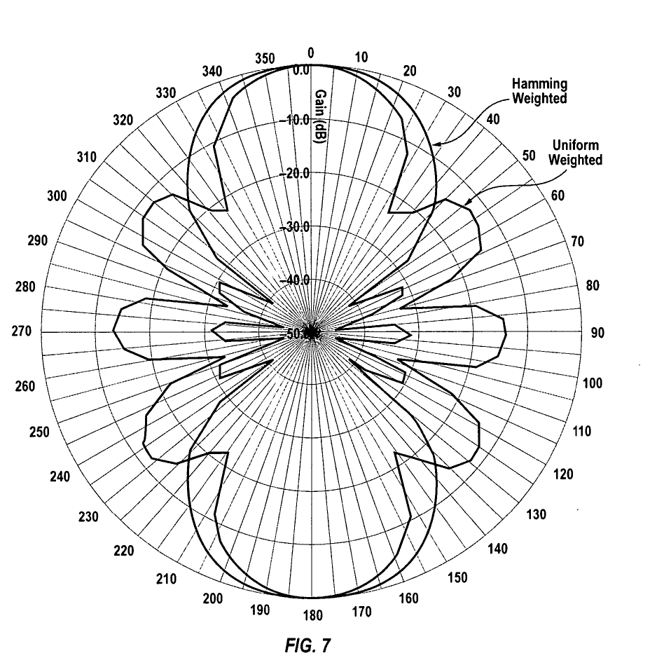

The comparison of the phased array antenna beam pattern for the uniformly weighted phased array antenna and the Hamming weighted phased array antenna are shown in FIG. 7. For the uniformly weighted array in the example, the 3 dB beamwidth is about 35 degrees and the first side lobe is down from the main lobe by −13.2 dB. In the Hamming weighted phased array, the main lobe is wider at about 50 degrees and the first side lobe is down from the main lobe by about −31 dB. The advantage of beam forming in this case is very good suppression of interferers which are off-axis by over 40 degrees. This example demonstrates beam forming without beam steering; however beam steering can also be applied in addition to beam forming and the advantage of both can be achieved. In addition, if tolerances in the gain control modules can be addressed, other beam weighting choices such as Blackman, Kaiser, Kaiser-Bessel, can also become available. It should be noted that the uniform weighted array may have more gain than the beam-formed one. In the example above, the 5-element array has about 7 dB gain whereas the beam-formed array has about 5 dB gain. The reduction in “overall gain” has decreased; however, the major advantage for some applications is that the sidelobes are substantially reduced. Thus it may be advantageous generally to trade-off some gain for improved sidelobes performance, depending on the particular application.

Having described the phased array antenna concept, it is useful to illustrate a practical example. The bands in which some common wireless services operate are as follows:

WiFi—2.4 GHz and 5.8 GHz

Bluetooth—2.4 GHz

Cellular—800 MHz and 1.9 GHz.

Taking these disparate bands into account, the phased array antenna should have a sufficient number of antenna elements and antenna element spacing such that the array is flexible enough across a wide range of operating frequencies. The nominal operating frequencies for the bands mentioned are shown in Table 1-1, along with their corresponding wavelengths.

TABLE 1-1

| Nominal Center Frequency (MHz) | Nominal Wavelenght (cm) |
|---|---|
| 800 | 37.5 |
| 1900 | 15.8 |
| 2400 | 12.5 |
| 2500 | 12.0 |

With the above in mind, an N element array which has an overall length of 9.375 cm (λ/4 at 800 MHz) can be selected.

9.4 cm (λ/4 at 800 MHz) (2 element)

3.9 cm (λ/4 at 1900 MHz) (3 element)

3.1 cm (λ/4 at 2400/2500 MHz) (4 element)

This allows for an overall array length of about 12 cm. The elements can be operated as a phased array in cases when directivity/null steering is required, or the antenna elements may simply be directly connected to a MIMO (multiple-input multiple-output) transceiver. The size of the array allows for a substantial ground plane to be realized, which is an important consideration in maximizing the performance of each individual antenna subsystem element. In the case of the two-element 800 MHz configuration, sidelobe suppression of 6 dB can be achieved, as well as the ability to steer nulls. Good unidirectional endfire performance can also be realized, as well as the additional main lobe gain from the two elements. In the case of the three-element 1900 MHz configuration, sidelobe suppression of 10 dB can be achieved, as well as the ability to steer nulls. Good unidirectional endfire performance can also be realized, as well as the additional main lobe gain from the three elements. In the case of the 4 element 2400/2500 MHz configuration, sidelobe suppression of about 12 dB can be achieved, as well as the ability to steer nulls. Good unidirectional endfire performance can also be realized, as well as the additional main lobe gain from the four elements.

To accomplish the above, a configuration having a total of nine antenna elements etched into a single printed circuit board can be used. The phase control required would be on the order of 180 degrees maximum across the linear array.

With reference to FIG. 3, multiplexing circuit (MUX) 304 is provided in order to improve transmit and receive performance for all technologies used by the resident and host wireless communication modules (110, 206, 208 and 210) of laptop computer 200 or similar, small form factor computing devices (PDAs, etc.). This is accomplished by the use of a single antenna subsystem (antenna module 104, FIG. 1). Preferably, as seen from FIG. 8, all of the antenna subsystem elements of module 104 are located on a single printed circuit 800 board that provides a large ground plane 802 for all antenna elements. Since all of the antenna elements and associated hardware are integrated onto a single board 800, it greatly simplifies the installation onto the platform—that is, laptop 200 or the like—as well as simplifying the integration into the platform functionality. Since the ground plane 802 is provided as part of the centralized wireless communication system 100, there is no need to ensure that the platform itself (laptop 200) provides an effective ground plane for the antenna elements.

Another advantage that can be realized is isolation and control of path loss and phase loss between primary wireless engines and their respective antenna systems. This is addressed by providing a standard RF interface characteristic, namely a nominal 50Ω resistive load, as previously explained. This allows for a common interface impedance for all wireless modules and eliminates the need to match the RF port of the modules, as long as the wireless module has a 50Ω impedance. In this way the losses due to impedance mismatching are dramatically reduced, and the effort required to integrate the wireless module into the platform is greatly reduced.

Yet another advantage is improved reuse and control of antenna systems within the platform (laptop 200). The antenna elements A₁-Aₙ in array 105 provide electrical band switching functionality. For example, the same element used for 1900 MHz operation could be electrically switchable between 1900, 2400, and 2500 MHz. In this way, the total number of antenna elements required for four band operation in Table 1-1 above could be reduced from 9 to 5 elements. Although the spacing between the three elements used to fabricate the phased array for 1900, 2400 and 2500 MHz may not be optimal, a substantial increase in the overall antenna performance is achieved.

Another advantage is improved control of multiple wireless technologies in one subsystem due to the ability of system 100 to select a wide range of antenna modes. These include:
the simple case in which a wireless module is connected to a single antenna element
the case in which a phased array configuration is selected to achieve improved wireless module performance through improved antenna performance
the case in which a wireless module that is capable of supporting MIMO can have each MIMO port routed to an individual antenna element.

Another advantage is a better reference design framework for platform manufacturers, such as manufacturers of laptop 200, to implement multiple wireless technologies with faster time to market and lower engineering development risk. This is facilitated by the fact that a single centralized wireless communication system 100 can operate with multiple wireless technologies in an almost limitless number of combinations.

Yet another advantage is the simplification of the antenna subsystem platform installation/integration into the laptop 200 or small form factor device by providing a flexible fully integrated antenna module 104, minimizing the effort and expertise required by the platform (laptop 200) manufacturer. This is addressed through the creation of a complete integrated antenna system in which the OEM need only connect the wireless module(s) to a connector on the centralized wireless communication system 100 and all of the routing from the connector to the appropriate antennas is built in and performed by the centralized wireless communication system 100 functionality and the onboard controller 102. There is no need to deal with the individual antenna elements, impedance matching, and so forth. The centralized wireless communication system 100 thus essentially provides a complete modular plug-in antenna system which can support multiple wireless technologies.

A simple single pole quadruple throw and single pole double throw RF switch set to implement the switching function of RF MUX 304 is shown in FIG. 9. These switches demonstrate simple means for antenna switching using PIN diodes. Other methods are possible using relays, GaAs FET transistors, and so on. Similar means can be used to implement a matrix switch or MUX which can interconnect N wireless modules with M antennas. Such a configuration achieves an M×N switch or MUX. For the purpose of the following example with will use situation in which we have three wireless modules and four antenna subsystems which we wish to connect in various fashions.

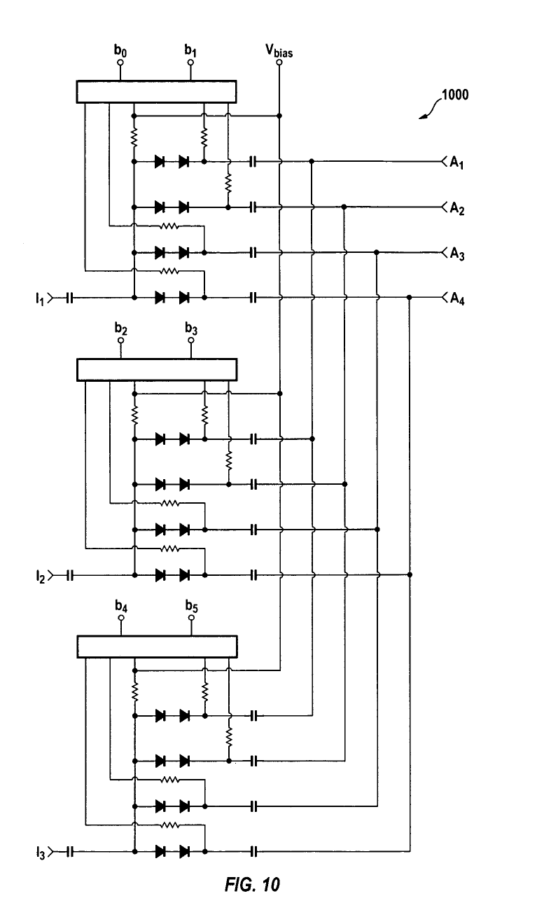

FIG. 10 provides an example of 3 in/4 out RF switch matrix or MUX 1000 to accommodate the situation in which three wireless modules and four antenna subsystems are to be connected in various fashions. Switch matrix 1000 has 6 digital control bits (b₀-b₅) to select various routings of the inputs to the outputs. Although the term input and output are used, the MUX is actually bi-directional. Thus it supports both the transmit and receive functionality of a wireless transceiver. It should be pointed out that multiple routings are possible. If the 6 digital control bits are 101101, the input I₁ is routed to Aₗ, input I₂ is routed to A₂, and I₃ is routed to A₃.

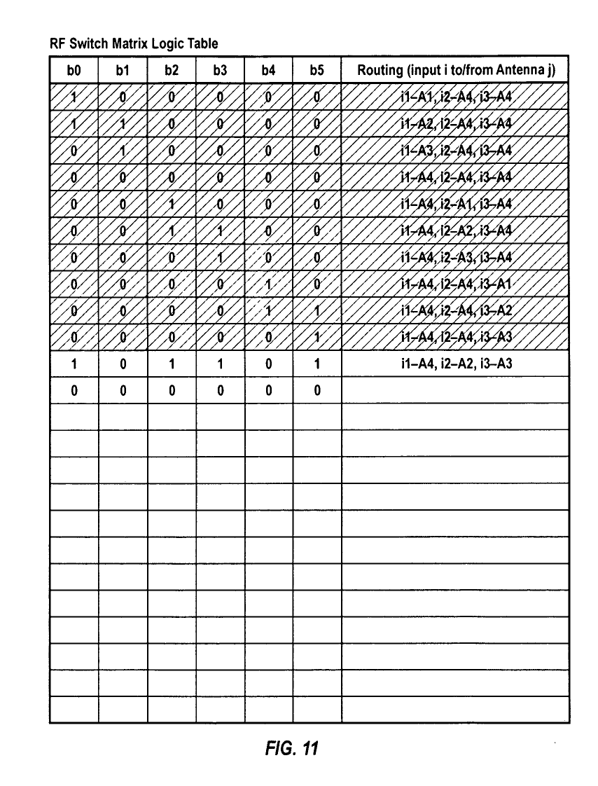

FIG. 11 provides a logic table for the MUX 1000 illustrated in FIG. 10. A different switching multiplexer can be used to implement a phased array antenna implementation, which would require more complex switching and possibly power splitter/combiners.

Returning to the QoS module 306 (FIG. 3), it may take the form of a software and/or firmware application which can run on the host computer 200, although it is possible to run it on the controller 102 in the centralized wireless communication system 100. The software/firmware application retrieves various information from the wireless modules (110, 206, 208 and 210) operating in the platform 200 and configures the antenna subsystem or module 104 to achieve as needed. For example, it may configure the antenna module 104 to perform any of the following or combinations of the following:
minimize the power consumption of the wireless modules (110, 206, 208 and 210) by selecting the wireless module which will consume the least energy that can still support the application running on the platform 200.
select the wireless module (110, 206, 208 and 210) which has a specific level of performance required to meet the user application requirements, such as the need for some minimum net data rate.
configure the antenna module 104 such that a single antenna Aₙ is used for the wireless module (110, 206, 208 and 210), and one or more performance parameters are optimized by selecting the antenna mode which yields the best overall performance. This is accomplished through for example:
   selecting a vertically polarized antenna and a horizontally polarized antenna and programming the operating frequency to be the nominal operating frequency of the wireless module, then switching between the vertically and horizontally polarized antenna and selecting which antenna yields the highest signal strength.
   selecting a vertically polarized antenna and a horizontally polarized antenna and programming the operating frequency to be the nominal operating frequency of the wireless module, then switching between the vertical and horizontally polarized antenna and selecting which antenna yields the lowest Error Vector Magnitude (EVM).
   selecting a vertically polarized antenna and a horizontally polarized antenna and programming the operating frequency to be the nominal operating frequency of the wireless module, then switching between the vertically and horizontally polarized antenna and selecting which antenna yields the lowest Frame Error Rate.
   selecting a vertically polarized antenna and a horizontally polarized antenna and programming the operating frequency to be the nominal operating frequency of the wireless module, then switching between the vertically and horizontally polarized antenna and selecting which antenna yields the lowest Bit Error Rate.
configure the antenna module 104 such that a phased array antenna is used for a wireless module (110, 206, 208 and 210), and one or more performance parameters are optimized by steering the antenna main lobe (sweeping the scan angle) and selecting the scan angle that yields the best overall performance. This can be accomplished by:
   configuring the phased array antenna using the MUX 304 and programming the operating frequency to be the nominal operating frequency of the wireless module (110, 206, 208 and 210), then scanning the angle to select the angle that yields the highest signal strength. This may additionally involve selecting 2, 3, or more elements Aₙ in the array 105 and selecting different element separations. The number of elements, element separation and scan angle that yields the highest signal strength is then selected.
   configuring the phased array antenna using the MUX 304 and programming the operating frequency to be the nominal operating frequency of the wireless module (110, 206, 208 and 210), then scanning angle and selecting the scan angle that yields the highest signal strength. This may additionally involve selecting 2, 3, or more elements Aₙ in the array 105 and selecting different element separations. The number of elements, element separation and scan angle that yields the lowest Error Vector Magnitude (EVM) would be selected.
   configuring the phased array antenna using the RF MUX 304 and programming the operating frequency to be the nominal operating frequency of the wireless module (110, 206, 208 and 210), then scan angle and selecting the scan angle that yields the highest signal strength. This may additionally involve selecting 2, 3, or more elements Aₙ in the array and selecting different element separations. The number of elements, element separation and scan angle that yields the lowest frame error rate would be selected.
   configuring the phased array antenna using the RF MUX 304 and programming the operating frequency to be the nominal operating frequency of the wireless module (110, 206, 208 and 210), then scanning the angle and selecting the scan angle that yields the highest signal strength. This may additionally involve selecting 2, 3, or more elements Aₙ in the array and selecting different element separations. The number of elements, element separation and scan angle that yields the lowest bit error rate would be selected.

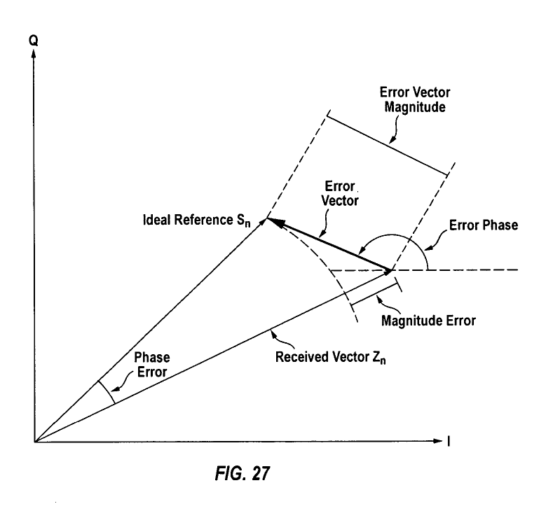

Standards such as 3GPP provide a definition of EVM (Error Vector Magnitude) as a measure of the difference between a reference waveform and the measured waveform. This difference is called the error vector. Both waveforms pass through a matched Root Raised Cosine filter with bandwidth 3.84 MHz and roll-off α=0.22. Both waveforms are then further modified by selecting the frequency, absolute phase, absolute amplitude and chip clock timing so as to minimize the error vector. The EVM result is defined as the square root of the ratio of the mean error vector power to the mean reference power expressed as a percentage. The measurement interval is one timeslot as defined by the CPICH (when present); otherwise the measurement interval is one timeslot starting with the beginning of the SCH. The requirement is valid over the total power dynamic range. FIG. 27 illustrates the error vector and its components. In a practical communication system, the EVM metric is degraded by a number of factors such as poor signal strength, resulting in a low SNR, co-channel/adjacent channel interference from other wireless communication devices, and electromagnetic interference from nearby electrical devices.

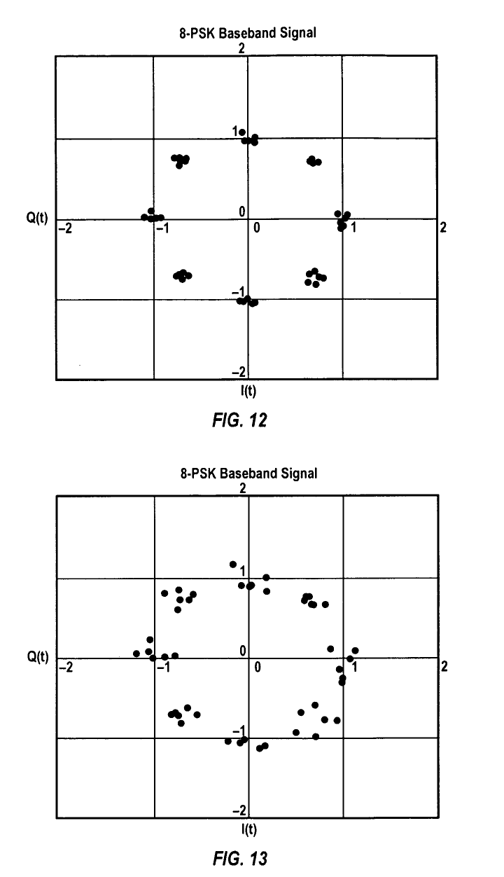

An example of an 8-PSK Baseband signal with a Low EVM is shown in FIG. 12, wherein there are 8 samples per symbol and they are concentrated around the points of the ideal 8-PSK constellation. An example of an 8-PSK baseband signal with a high EVM is shown in FIG. 13. In this case, the EVM is 1.5 times that of the low EVM example.

The wireless modules (110, 206, 208 and 210) are connected to the host computer 200 over a common data bus architecture 214 such as USB, PC Card (PCMCIA), or the like. They may also be connected directly to individual I/O ports on the platform (i.e., RS-232). The QoS application can access various information from the wireless modules (110, 206, 208 and 210) (such as RSSI, EVM, Frame Error Rate, Bit Error Rate, current consumption, etc.) through the data bus 214. With this information, the QoS application on the manager 306 can then configure the antenna array 105 via the controller 102. This configuration can range from very simple to quite complex depending on the nature of the wireless module (110, 206, 208 and 210). A very simple method relies on knowing that one of the wireless modules for example is a Bluetooth device, and nothing more than selecting a single antenna and programming the operating frequency of the antenna would be required. In another case, a wireless module (110, 206, 208 and 210) may require three antenna elements to operate at 2.4 GHz in a MIMO configuration. In this case, the controller 102 configures the RF MUX 304 such that three antennas Aₙ are selected and the operating bands of the elements would be selected to be 2.4 GHz. In yet another case, wireless module 3 may initially operate in GSM/GPRS mode at 1.9 GHz. Although the signal strength may be very high, it could encounter a poor EVM metric. In that case, the QoS manager 306 would cue the controller 102 to operate in the phase array mode and select the array antennas Aₙ to operate at 1.9 GHz. It would then sweep the scan angle to minimize the EVM metric. This could be done using a brute force scan angle sweep, or the scan angle could be adoptively swept using an adaptive algorithm such as least squares or Kalman to select the optimum scan angle.

Controller 102 performs a number of functions, but these are generally associated with configuring the RF MUX/Gain Control/Phase Control/ANC Control under the direction of the Host Computer. One of these means of control in from the QoS manager 306 as previously described. However, the controller 102 can establish communications with other applications on the host laptop computer 200 in situations in which it is advantageous for these applications to have a more intimate control over the antenna subsystem or module 104. For this reason, an interface protocol to the controller 102 such that the antenna subsystem 104 may be configured as desired can be provided, essentially in the form of a device driver interface. In addition, the controller 102 can establish communications with any of the wireless modules (206, 208 and 210) on the host computer platform 200 in which it is advantageous for these applications to have more intimate control over the antenna subsystem 104. This could provide means whereby the centralized wireless communication system 100 can operate in a plug-and-play mode where it attempts to discover which wireless modules (110, 206, 208 and 210) are available and what their antenna needs are in order to configure itself to meet this antenna functionality. Further, the host computer operating system 308 (FIG. 3) can establish communications with controller 102 in a plug and play fashion to determine how this resource can be utilized by other hardware and/or software under its control.

### EXAMPLE

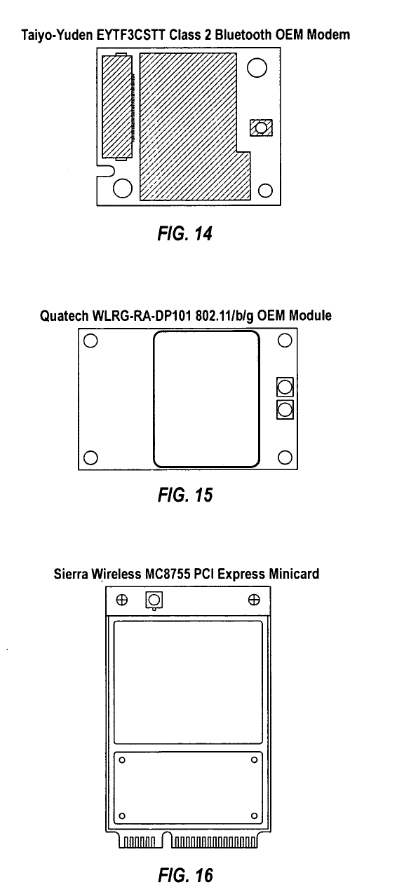

A Lenovo™ laptop is used the as the platform 200, with three available wireless technologies: a Bluetooth™ embedded module, a WiFi™ module, and a Sierra Wireless™ MC8775 HSDPA PCI Express Mini Card. A PIFA (planar inverted f-antenna) and stripline antennas are used as the antenna module 104. In all three cases, the wireless modules assume a 50Ω RF interface. The Bluetooth™ is an OEM module from Taiyo Yuden, the EYTF3CSTT Class 2 Bluetooth OEM Module. The form factor is shown in FIG. 14. It has a single antenna connector, and the operating frequency is 2.402-2.48 GHz. It uses a USB interface. The WiFi™ 802.11b/g module used is a Quatech WLRG-RA-DP 101 OEM module. The form factor is shown in FIG. 15. The operating frequency is 2.4-2.4835 GHz, and it uses a Compact Flash (CF) interface. This module has two antenna ports which supports receive diversity. The Sierra Wireless™ MC8755 PCI Express MiniCard is shown in FIG. 16.

The antenna module 104 in this example may take one of many possible configurations and permutations. Some of these will be described further below, from the simple to complex, with the understanding that others are possible. The antenna module 104, shown as part of the centralized wireless communication system 100, has the following key elements, described with reference to FIG. 17:
4 RF connectors (J₁-J₄) 1702: one for the 8755 Sierra Wireless™ MC8755 PCI Express MiniCard, one for the Bluetooth module, and two for the Wi-Fi module.
one interface connector 1704 to interface the controller 102 to the host processor 216 (FIG. 3),
7 antennas 1706, these being:
   A_{1V}—Vertical polarized element for the 8755
   A_{2V}—Vertical polarized element for the 8755
   A_{3V}—Vertical polarized element for the 8755
   A_{4H}—Horizontal polarized element for the 8755
   A_{5V}—Vertical polarized element for the 802.11b/g Module
   A_{6V}—Vertical polarized element for the 802.11b/g Module
   A_{7V}—Vertical polarized element for the Bluetooth Module
One control subsystem 1708 which contains the RF MUX 304 (FIG. 3), beamforming circuitry (not shown), ANC 109 (FIG. 3), and controller 102.

The centralized wireless communication system 100 may be mounted on a regular PCB used for RF application (i.e., G10 epoxy), or it may be fabricated with a flexible PCB material. The flexible PCB has advantages in that it can be placed on the back cover of a laptop display and held in place with an adhesive. For the purpose of this example, a flex-PCB implementation is used with stripline antenna elements on the flex.

One mode of operation of centralized wireless communication system 100 of FIG. 17 is dumb mode, in which there is no beam steering. The function of the RF MUX 204 and controller 102 is switch the RF connectors 1702 to the antenna elements appropriate for the wireless module. The can also operate to provide for bandswitching of the antennas. In dumb mode, there is no beam forming or beam steering. One purpose of this mode to simply allow the wireless modem integrator some flexibility in the antenna installation. If the OEM module supports MIMO, this code could select the antenna routing.

Another mode is simple mode. The system has three channels, these being WLAN, WiFi, and Bluetooth. The WiFi channel uses two antennas as part of its Rx Diversity functionality, and these are hardwired to vertically polarized antennas A₅ and A₆ via connectors J₂ and J₃ respectively. The bluetooth module is hardwired to antenna A₇ via connector J₄. The Wireless LAN (WLAN) antenna consists of four individual antenna elements A₁ to A₄ which are accessible via connector J₁. The antenna elements themselves are band switchable under control of the controller 102 in subsystem 1708. Various subassemblies and switches (not shown) are connected in the channel to provide:
single element vertically polarized antenna
single element horizontally polarized antenna
fixed beam steering of combinations of elements to achieve broadside and endfire characteristics.

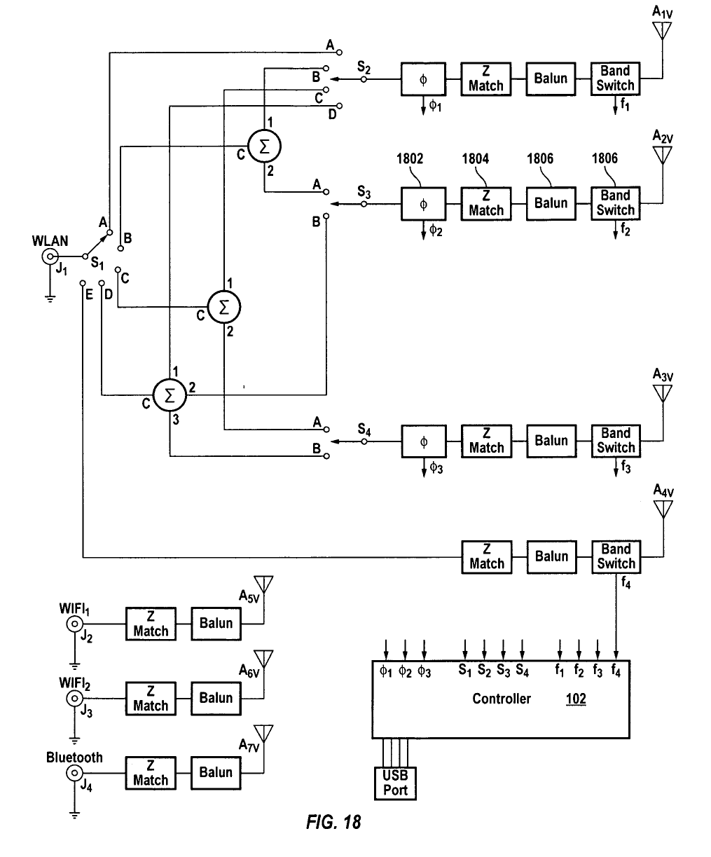

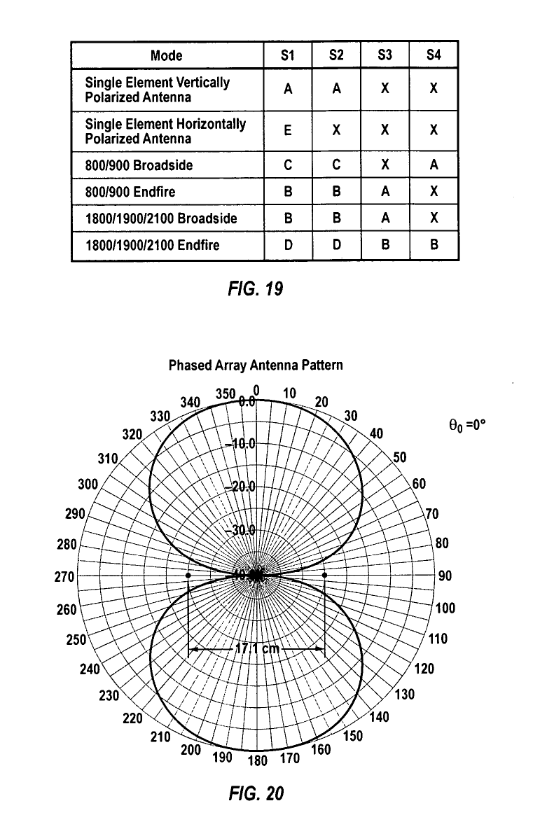

Referring to the block diagram in FIG. 18, there are four PIN Diode Switches (S₁-S₄) which are used to select the six WLAN antenna modes. These switches perform all of the signal routing from the connector J₁ through phase shifters (φ₁-φ₃) 1802, impedance matching networks (Z) 1804, baluns 1806, and band switches (f₁-f₄) 1808 to effect the desired antenna configuration. The switch blocks (S₁-S₄) are under control of the controller 102. A possible configuration for the six modes is shown in the table of FIG. 19.

The band switch blocks (f₁-f₄) 1808 are used to switch the antenna elements so that they operate at the appropriate center frequency required for the MC8755 wireless module. Baluns are used to convert the unbalanced feeds to balanced feeds for the dipole antenna elements used in this example. If monopole elements are used, then the baluns would not be used but a counterpoise may be required for the element. The band switching blocks (f₁-f₄) 1808 are under control of the controller 102.

The phase shifting blocks (φ₁-φ₃) 1802 select the phase delay required in the specific antenna elements to effect broadside or endfire mode in the phased array mode. The phase delays blocks (φ₁-φ₃) 1802 are under control of the controller 102.

The controller 102 itself is a simple 8-bit controller which controls the phase shifters, band select, and switches under control of the QoS manager 306 application running on the host laptop computer 200. In this case a standard USB bus interface is used to obtain a serial data communications interface with the host computer 200 as well as to obtain power from the host platform.

In this simple mode, the phase delays are fixed at 0 degrees and ±90 degrees. That is, the delays are switchable and not continuously variable. The gains are fixed for all elements, and the gain blocks can thus be removed from the circuit.

The Sierra Wireless 8755 module operates at 850, 900, 1800, 1900 and 2100 MHz.

800/900 MHz Bands

In these bands, the controller 102 uses vertically polarized elements A_{1V}, A_{2V}, and A_{3V}. In the broadside mode where the main lobe is at right angles to the array, only elements A_{1V} and A_{3V} need be used. They have a spacing of 17.1 cM. They are co-phased (0 degrees delay) and operated with equal gain. This provides an antenna pattern as shown in FIG. 20.

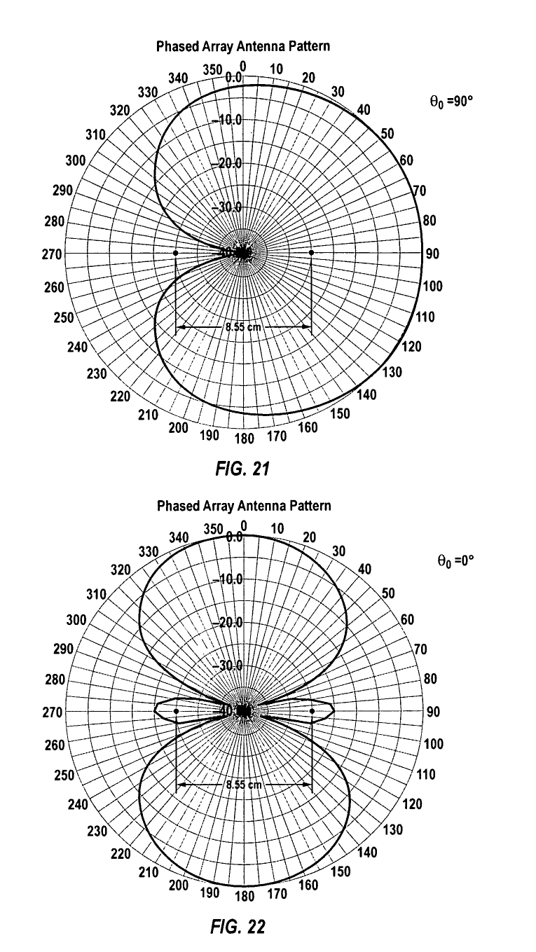

In the endfire mode, only two adjacent elements are used with a 90-degree scan angle and either A_{1V}/A_{2V}, or A_{2V}/A_{3V} are used as the active elements. They are spaced 8.55 cm apart. A 90-degree phase difference and equal gains are established. This provides an antenna pattern as shown in FIG. 21. The endfire beam can be directed in the opposite direction using a phase shift of −90 degrees.

1800/1900 MHz Bands

In this case, the element spacing does not quite work out to quarter wavelength multiples, but it is nevertheless close enough to be effective. In the broadside mode wherein the main lobe is at right angles to the array, only elements A_{1V} and A_{2V} are used, although A_{2V} and A_{3V} can equally work. The spacing is 8.55 cm. The antennas are be co-phased (0-degree delay) and operated with equal gain. This provides an antenna pattern as shown in FIG. 22.

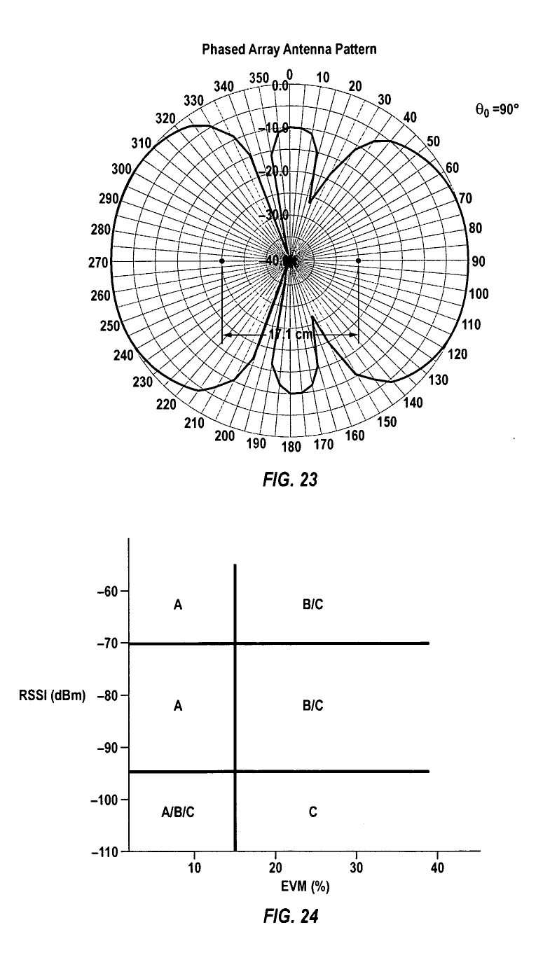

For the 1800/1900 MHz band endfire mode, all three antennas A_{1V}, A_{2V} and A_{3V} are used as the active elements. With a steering angle of 90 degrees in broadside mode, good nulls are obtained at 90 degrees to the main lobe. The overall length of 17.1 cM yields an element spacing of 0.53 wavelengths, which is not exactly the 0.5 desired, but still yields quite good performance. In the endfire mode, all three antenna A_{1V}, A_{2V} and A_{3V} are used as the active elements with a 90 scan angle. They are spaced 8.55 cm apart, which is about 0.53 wavelengths instead of the desired 0.5 wavelengths. There is a 90-degree phase difference and equal gains. This provides an antenna pattern as shown in FIG. 23. In this case, the endfire is more or less symmetric in either direction so there is no need to direct it in the opposite direction. Antenna A_{4H} is provided in the event that a horizontally polarized antenna provides better performance over a single element vertically polarized element or a multi-element vertically polarized phased array.

As previously explained, the subsystem 1708 (FIG. 17) including RF MUX 304, beamformer (not shown), and controller 102 operates as the switch matrix which interconnects the various RF connectors with the various antenna elements, controls the phase delays which effect the beam direction, and the controller which administers these functions under control of the QoS manager 306 application on the host platform 200. The subsystem 1708 can be customized for various applications and degrees of complexity required for the intended platform. For example, in the simple mode it can be fabricated with switched delays rather than continuously variable delays, and would not require variable gain elements. For the Bluetooth and 802.11b/g modules, the RF connectors 1702 would simply couple to an impedance matching network (not shown) then directly to the corresponding antennas since they need not be steerable. The MC8755 WLAN Wireless Module would couple to a switch metric that would select only three modes:
single element vertically polarized band switched
single element horizontally polarized band switched
multi-element vertically polarized phased array band switched
broadside mode
endfire mode.

Impedance matching from 50Ω to the specific impedance of the antenna would be performed as well. A fairly simple QoS strategy can be used. The controller 102 judges the signal quality as follows:
(1) determine the EVM for the particular channel it is receiving
(2) determine the Received Signal Strength Indication of the channel it is receiving
(3) with reference to a table or chart containing information such as that in FIG. 24, determine which antenna control mode maximizes the receive signal performance. In FIG. 24, the letter coding is assigned as follows;
   A—RSSI strong and EVM low for a single vertical element, so stick with a single vertically polarized antenna element.
   B—RSSI low and EVM low, so issue is low signal strength. Try a Horizontally polarized antenna element.
   C—Signal strength is low and/or EVM is high, so try a phased array configuration in an attempt to increase. Step the antenna through the broadside or endfire modes and select the mode which results in the best RSSI and/or EVM.

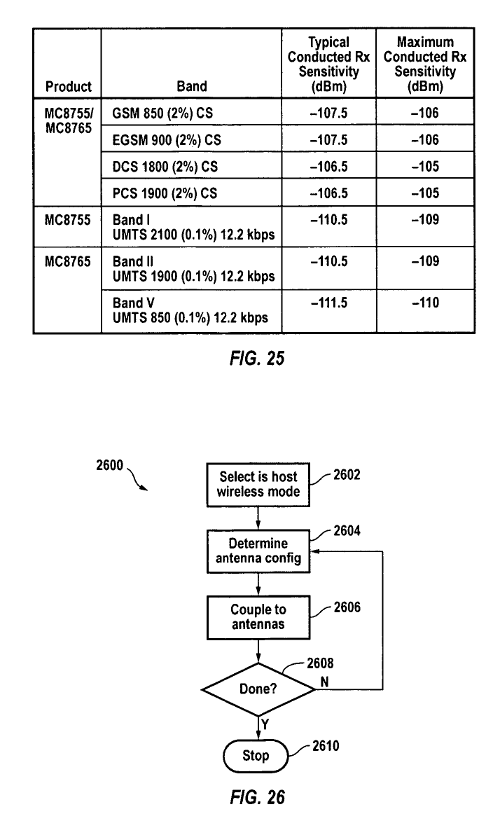

Some Receive Signal Strength metrics for the Sierra Wireless™ MC8744 are provided in FIG. 25.

Another mode possible is super smart mode, wherein, which enables selection not only of broadside and endfire phased arrays, but also provides beam steering and null steering. Such a mode relies on continuously adjustable phase delays and gains. Beam steering incorporates beam shaping to trade off phased array beam width versus integrated side lobe ratio. This mode also includes adaptive noise cancellation as described above.

Based on the above, a method that can be implemented to enable RF communication by a host device such as laptop 200 having one or more host wireless communication modules is described with reference to FIG. 26. Method 2600 includes selecting, at 2602, a first one of the host wireless communication modules. Once the selection is made, a determination, at 2604, of an antenna configuration specific to the selected wireless communication module is made. Then, at 2606, the first host wireless communication module is coupled to one or more antenna elements based on the determined configuration. It may follow that a second wireless communication module is then selected. The method then loops back and the antenna configuration specific to the second wireless communication module is determined at 2604, and the second wireless communication module is then coupled, at 2606, to one or more antenna elements based on the determined configuration. The process ends at 2610 when, at 2608, no more wireless modules are to be coupled.

The above are exemplary modes of carrying out the invention and are not intended to be limiting. It will be apparent to those of ordinary skill in the art that modifications thereto can be made without departure from the spirit and scope of the invention as set forth in the following claims.

1. A centralized wireless communication system for a host device having a host processor and one or more host wireless communication modules, the centralized wireless communication system comprising:
a controller;
one or more antenna elements; and
an RF multiplexer coupled to the one or more antenna elements and including one or more ports, the RF multiplexer configured to establish an RF communication path between one or more ports and one or more antenna elements based on instructions from the controller.

2. The system of claim 1, wherein the instructions from the controller are a function of a wireless communication service specific to a host wireless communication module.

3. The system of claim 2, wherein the controller establishes an antenna configuration associated with the wireless communication service based on communications from the host processor.

4. The system of claim 2, wherein the wireless communication service utilizes frequency in the 2.4 GHz band.

5. The system of claim 2, wherein the wireless communication service utilizes frequency in the 5.8 GHz band.

6. The system of claim 2, wherein the wireless communication service utilizes frequency in the 2.5 GHz band.

7. The system of claim 2, wherein the wireless communication service utilizes frequency in the 800 MHz band.

8. The system of claim 2, wherein the wireless communication service utilizes frequency in the 1.9 GHz band.

9. The system of claim 1, further comprising a resident wireless communication module coupled to one or more ports of the RF multiplexer, and wherein the instructions from the controller are a function of a wireless communication service specific to the resident wireless communication module.

10. The system of claim 1, wherein the ports are configured to present a standardized impedance value.

11. The system of claim 1, wherein said impedance value is about 50Ω.

12. The system of claim 1, wherein the controller is configured to operate at least one of the antenna elements alternately as a passive antenna element and as an active antenna element.

13. The system of claim 1, wherein the controller is configured to operate the one or more antennas to provide adaptive noise cancellation.

14. The system of claim 1, wherein at least one antenna element includes:
an antenna frequency control circuit;
a gain control circuit;
a phase control circuit; and
an impedance matching circuit.

15. The system of claim 14, wherein the antenna frequency control circuit is operable to configure the at least one antenna element as a dual frequency band antenna.

16. The system of claim 14, wherein the gain control circuit is operable to provide variable gain scaling.

17. The system of claim 14, wherein the phase control circuit is operable to provide variable phase shift.

18. The system of claim 14, wherein the controller is configured to control one or more of the antenna frequency control circuit, gain control circuit, phase control circuit, and impedance matching circuit so as to operate the at least one antenna as part of an active phased array.

19. The system of claim 14, wherein the controller is configured to control one or more of the antenna frequency control circuit, gain control circuit, phase control circuit, and impedance matching circuit so as to provide beam and/or null steering.

20. The system of claim 1, wherein the controller is configured to operate the at least one antenna as part of an active phased array.

21. The system of claim 1, wherein the controller is configured to operate in accordance with Quality of Service (QoS) metrics.

22. The system of claim 21, wherein the QoS metrics are provided by the host processor.

23. A host device comprising:
a host processor;
one or more host wireless communication modules;
a centralized wireless communication system including:
a controller;
one or more antenna elements; and
an RF multiplexer in communication with the one or more antenna elements and including one or more ports, the RF multiplexer configured to selectively couple one or more antenna elements to one or more ports based on instructions from the controller, said selective coupling being a function of a wireless service specific to a host wireless communication module.

24. The device of claim 23, wherein the instructions from the controller are a function of a wireless communication service specific to a host wireless communication module.

25. The device of claim 23, wherein the controller establishes an antenna configuration associated with the wireless communication service based on communications from the host processor.

26. The device of claim 24, wherein the wireless communication service utilizes frequency in the 2.4 GHz band.

27. The device of claim 24, wherein the wireless communication service utilizes frequency in the 5.8 GHz band.

28. The device of claim 24, wherein the wireless communication service utilizes frequency in the 2.5 GHz band.

29. The device of claim 24, wherein the wireless communication service utilizes frequency in the 800 MHz band.

30. The device of claim 24, wherein the wireless communication service utilizes frequency in the 1.9 GHz band.

31. The device of claim 23, further comprising a resident wireless communication module coupled to one or more ports of the RF multiplexer, and wherein the instructions from the controller are a function of a wireless communication service specific to the resident wireless communication module.

32. The device of claim 23, wherein the ports are configured to present a standardized impedance value.

33. The device of claim 23, wherein said impedance value is about 50Ω.

34. The device of claim 23, wherein the controller is configured to operate at least one of the antenna elements alternately as a passive antenna element and as an active antenna element.

35. The device of claim 23, wherein the controller is configured to operate the one or more antennas to provide adaptive noise cancellation.

36. The device of claim 23, wherein at least one antenna element includes:
an antenna frequency control circuit;
a gain control circuit;
a phase control circuit; and
an impedance matching circuit.

37. The device of claim 36, wherein the frequency control circuit is operable to configure the at least one antenna element as a dual frequency band antenna.

38. The device of claim 36, wherein the gain control circuit is operable to provide variable gain scaling.

39. The device of claim 36, wherein the phase control circuit is operable to provide variable phase shift.

40. The device of claim 36, wherein the controller is configured to control one or more of the antenna frequency control circuit, gain control circuit, phase control circuit, and impedance matching circuit so as to operate the at least one antenna as part of an active phased array.

41. The device of claim 36, wherein the controller is configured to control one or more of the antenna frequency control circuit, gain control circuit, phase control circuit, and impedance matching circuit so as to provide beam and/or null steering.

42. The device of claim 23, wherein the controller is configured to operate the at least one antenna as part of an active phased array.

43. The device of claim 23, wherein the controller is configured to operate in accordance with Quality of Service (QoS) metrics.

44. The device of claim 43, wherein the QoS metrics are provided by the host processor.

45. A method for enabling RF communication by a host device having one or more host wireless communication modules, the method comprising:
selecting a first one of the host wireless communication modules;
determining an antenna configuration specific to the first host wireless communication module; and
coupling the first host wireless communication module to one or more antenna elements based on the determined configuration.

46. The method of claim 45, further comprising:
selecting a second wireless communication module;
determining an antenna configuration specific to the second wireless communication module; and
coupling the second wireless communication module to one or more antenna elements based on the determined configuration.

47. The method of claim 45, wherein the one or more antenna elements are provided on a printed circuit board (PCB) on which the second wireless communication module is disposed.

48. The method of claim 45, further comprising using the one or more antennas to provide adaptive noise cancellation.

49. The method of claim 45, further comprising operating one or more antenna elements alternately as a passive antenna element and as an active antenna element.

50. The method of claim 45, further comprising operating one or more antenna elements as part of an active phased array.

51. The method of claim 45, wherein the antenna configuration is specific to wireless communication in the 2.4 GHz band.

52. The method of claim 45, wherein the antenna configuration is specific to wireless communication in the 5.8 GHz band.

53. The method of claim 45, wherein the antenna configuration is specific to wireless communication in the 2.5 GHz band.

54. The method of claim 45, wherein the antenna configuration is specific to wireless communication in the 800 MHz band.

55. The method of claim 45, wherein the antenna configuration is specific to wireless communication in the 1.9 GHz band.

56. The method of claim 45, further comprising operating the host wireless communication module in accordance with Quality of Service (QoS) metrics.

57. The method of claim 45, wherein the QoS metrics are provided by a host processor of the host device.
